(19) United States
(12) Patent Application Publication
(10) Pub. No.: US 2026/0003933 A1
(43) Pub. Date: Jan. 1, 2026

(54) REDUNDANT FUSED MULTIPLY-ACCUMULATE CIRCUITS FOR ERROR DETECTION IN MATRIX OPERATIONS UNIT

(71) Applicant: Intel Corporation, Santa Clara, CA (US)

(72) Inventors: Sagi MELLER, Zichron Yaakov (IL); Michael MISHAELI, Haifa (IL); Arkady BRAMNIK, Kiryat Motzkin (IL); Amit GRADSTEIN, Binyamina (IL)

(73) Assignee: Intel Corporation, Santa Clara, CA (US)

(21) Appl. No.: 18/759,720

(22) Filed: Jun. 28, 2024

(51) Int. Cl. G06F 17/16; G06F 7/544

(52) U.S. Cl. CPC G06F 17/16; G06F 7/5443

(57) ABSTRACT

A processor of an aspect includes a matrix operations unit. The matrix operations unit is to perform a matrix operation on a first source matrix and a second source matrix to generate a result matrix. The matrix operations unit includes a plurality of sets of circuits. The processor also includes a redundant set of circuits and a comparison unit coupled with the matrix operations unit and coupled with the redundant set of circuits. The comparison unit is to compare a first result generated by an indicated set of circuits of the plurality of sets of circuits with a second result generated by the redundant set of circuits. Each of the first and second results are to be generated based on a same set of input data from the first and second source matrices. Other processors, methods, and systems are disclosed.

### BACKGROUND

### Technical Field

Embodiments described herein generally relate to computer processor architecture, and more specifically to processing matrices.

### Background Information

During operation, processors and other semiconductor devices occasionally experience errors. These errors may be either soft errors or hard errors.

The soft errors may represent temporary, non-permanent errors, glitches, or malfunctioning that do not involve damage to the processor or semiconductor device, such as, for example, transient bit flips, erroneous outputs from memory cells or circuitry, or the like. The soft errors may be caused by one or more of cosmic radiation, neutrons, alpha particles, electromagnetic pulses, or the like. For example, a charged particle may impact the semiconductor device or be generated in the semiconductor device causing the value of a bit to change from 0 to 1 or from 1 to 0. Normal operation can often be achieved by restarting the processor or semiconductor device, overwriting the erroneous data, etc.

The hard errors may often but not always represent more permanent and/or less recoverable errors, glitches, or malfunctioning due to damage to the processor or semiconductor device, such as, for example, stuck bits, stuck transistors, stuck circuit elements, or other damage to circuitry or memory cells. The hard errors may be caused by one or more of manufacturing defects, defects once deployed, excessive temperature variation, voltage stress, latent faults, aging, radiation, or a combination. Such hard errors may be present when the semiconductor device is initially manufactured or can develop over time (e.g., from weeks to months or longer). Restarting the semiconductor device or overwriting the erroneous data commonly do not correct the hard error.

Such soft errors and hard errors can lead to Silent Data Errors (SDEs). SDEs are also sometimes referred to as Silent Data Corruption (SDC). SDEs tend to be particularly problematic because as their name suggests they occur silently or without being detected. As a result, the SDEs may lead to data loss and/or corruption in processors and other semiconductor devices. For example, SDEs may cause a processor to compute an incorrect or nonsense result. This often represents a significant problem. Although SDEs tend to occur infrequently, servers, data centers, cloud computing sites, and the like, typically have many processors, which increases the likelihood that SDEs will occur.

### BRIEF DESCRIPTION OF THE DRAWINGS

The invention may best be understood by referring to the following description and accompanying drawings that are used to illustrate embodiments. In the drawings:

FIG. 1A illustrates an embodiment of configured tiles.

FIG. 1B illustrates an embodiment of configured tiles.

FIG. 2 illustrates several examples of matrix storage.

FIG. 3 illustrates an embodiment of a system utilizing a matrix (tile) operations accelerator.

FIGS. 4 and 5 show different embodiments of how memory is shared using a matrix operations accelerator.

FIG. 6 illustrates an embodiment of matrix multiply accumulate operation using tiles (“TMMA”).

FIG. 7 illustrates an embodiment of a subset of the execution of an iteration of a chained fused multiply accumulate instruction.

FIG. 8 illustrates an embodiment of a subset of the execution of an iteration of a chained fused multiply accumulate instruction.

FIG. 9 illustrates an embodiment of a subset of the execution of an iteration of a chained fused multiply accumulate instruction.

FIG. 10 illustrates an embodiment of a subset of the execution of an iteration of chained fused multiply accumulate instruction.

FIG. 11 illustrates power-of-two sized SIMD implementations wherein the accumulators use input sizes that are larger than the inputs to the multipliers according to an embodiment.

FIG. 12 illustrates an embodiment of a system utilizing matrix operations circuitry.

FIG. 13 illustrates an embodiment of a processor core pipeline supporting matrix operations using tiles.

FIG. 14 illustrates an embodiment of a processor core pipeline supporting matrix operations using tiles.

FIG. 15 illustrates an example of a matrix expressed in row major format and column major format.

FIG. 16 illustrates an example of usage of matrices (tiles).

FIG. 17 illustrates an embodiment of a method of usage of matrices (tiles).

FIG. 18 illustrates support for configuration of the usage of tiles according to an embodiment.

FIG. 19 illustrates an embodiment of a description of the matrices (tiles) to be supported.

FIGS. 20(A)-(D) illustrate examples of register(s).

FIG. 21 is a block diagram of an embodiment of a processor.

FIG. 22 is a block flow diagram of an embodiment of a method.

FIG. 23 is a block diagram of a first more detailed embodiment of a processor showing first circuitry, second circuitry, and third circuitry.

FIG. 24 is a block diagram of a second more detailed embodiment of a processor having a matrix operations unit with columns of FMA circuits and a redundant column of FMA circuits.

FIG. 25 is a block diagram of an embodiment of a control and/or configuration register having at least one field to store one or more bits to enable and/or disable use of a redundant set of FMA circuits and a comparison unit.

FIG. 26 is a block diagram of an embodiment of a control and/or configuration register having at least one field to store one or more bits to configure and/or control and/or change a rate associated with use of a redundant set of FMA circuits and a comparison unit.

FIG. 27 is a block diagram of an embodiment of a comparison unit showing example inputs and outputs.

FIG. 28 illustrates an example computing system.

FIG. 29 illustrates a block diagram of an example processor and/or System on a Chip (SoC) that may have one or more cores and an integrated memory controller.

FIG. 30(A) is a block diagram illustrating both an example in-order pipeline and an example register renaming, out-of-order issue/execution pipeline according to examples.

FIG. 30(B) is a block diagram illustrating both an example in-order architecture core and an example register renaming, out-of-order issue/execution architecture core to be included in a processor according to examples.

FIG. 31 illustrates examples of execution unit(s) circuitry.

FIG. 32 is a block diagram of a register architecture according to some examples.

FIG. 33 illustrates examples of an instruction format.

FIG. 34 illustrates examples of an addressing information field.

FIG. 35 illustrates examples of a first prefix.

FIGS. 36(A)-(D) illustrate examples of how the R, X, and B fields of the first prefix in FIG. 35 are used.

FIGS. 37(A)-(B) illustrate examples of a second prefix.

FIG. 38 illustrates examples of a third prefix.

FIG. 39 is a block diagram illustrating the use of a software instruction converter to convert binary instructions in a source instruction set architecture to binary instructions in a target instruction set architecture according to examples.

### DETAILED DESCRIPTION OF EMBODIMENTS

The present disclosure relates to methods, apparatus, and systems to detect errors in matrix operations units using a redundant set of circuits. In the following description, numerous specific details are set forth (e.g., specific processor configurations, microarchitectural details, sequences of operations, etc.). However, embodiments may be practiced without these specific details. In other instances, well-known circuits, structures, and techniques have not been shown in detail to avoid obscuring the understanding of the description.

In many mainstream processors, handling matrices is a difficult and/or instruction intensive task. For example, rows of a matrix could be put into a plurality of packed data (e.g., SIMD or vector) registers and then operated on individually. For example, an add two 8×2 matrices may require a load or gather into four packed data registers depending upon data sizes. Then a first add of packed data registers corresponding to a first row from each matrix is performed and a second add of packed data registers corresponding to a second row from each matrix is performed. Then the resulting packed data registers are scattered back to memory. While for small matrices this scenario may be acceptable, it is often not acceptable with larger matrices.

### Discussion

Described herein are mechanisms to support matrix operations in computer hardware such as central processing units (CPUs), graphic processing units (GPUs), and accelerators. The matrix operations utilize 2-dimensional (2-D) data structures representing one or more packed regions of memory such as registers. Throughout this description, these 2-D data structures are also sometimes referred to as tiles. Note that a matrix may be smaller than a tile (use less than all a tile) or utilize a plurality of tiles (the matrix is larger than the size of any one tile). Throughout the description, matrix (tile) language is used to indicate operations performed using tiles that impact a matrix; whether or not that matrix is larger than any one tile is not typically relevant.

Each tile may be acted upon by different operations such as those that are detailed herein and include, but are not limited to: matrix (tile) multiplication, tile add, tile subtract, tile diagonal, tile zero, tile transform, tile dot product, tile broadcast, tile row broadcast, tile column broadcast, tile multiplication, tile multiplication and accumulation, tile move, etc. Additionally, support for operators such as the use of a scale and/or bias may be used with these operations or in support of non-numeric applications in the future, for instance, OpenCL “local memory,” data compression/decompression, etc.

Portions of storage (such as memory (non-volatile and volatile), registers, cache, etc.) are arranged into tiles of different horizontal and vertical dimensions. For example, a tile may have horizontal dimension of 4 (e.g., four rows of a matrix) and a vertical dimension of 8 (e.g., 8 columns of the matrix). Typically, the horizontal dimension is related to element sizes (e.g., 2-, 4-, 8-, 16-, 32-, 64-, 128-bit, etc.). Multiple datatypes (single precision floating-point, double precision floating-point, integer, etc.) may be supported.

### Exemplary Usage of Configured Tiles

In some embodiments, tile parameters can be configured. For example, a given tile may be configured to provide tile options. Exemplary tile options include but are not limited to a number of rows of the tile, a number of columns of the tile, whether the tile is VALID, and whether the tile consists of a PAIR of equal-sized tiles.

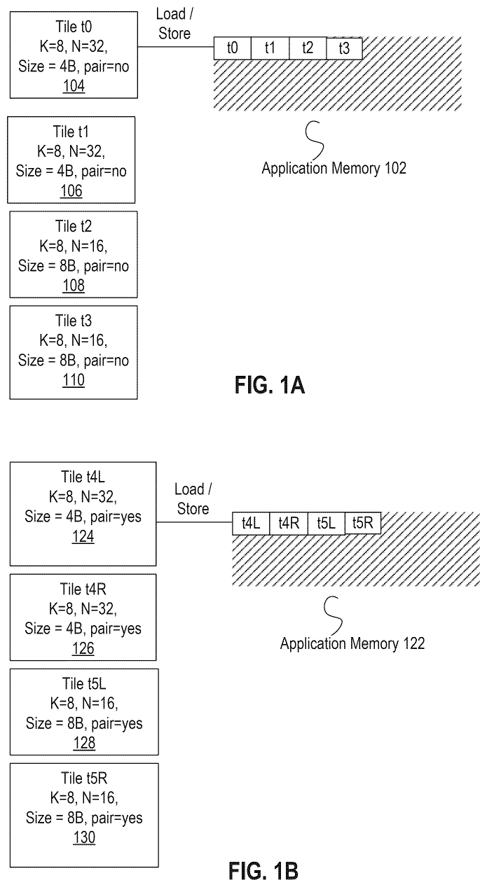

FIG. 1A illustrates an embodiment of configured tiles. As shown, 4 kB of application memory 102 have stored thereon 4 1 kB titles, tile t0 104, tile t1 106, tile t2 108, and tile t3 110. In this example, the 4 tiles do not consist of pairs, and each have elements arranged in rows and columns. Tile t0 104 and tile t1 106 have K rows and N columns of 4-byte elements (e.g., single precision data), where K equals 8 and N=32. Tile t2 108 and tile t3 110 have K rows and N/2 columns of 8-byte elements (e.g., double precision data). As the double precision operands are twice the width of single precision, this configuration is consistent with a palette, used to provide tile options, supplying at least 4 names with total storage of at least 4 kB. In operation, the tiles can be loaded from and stored to memory using load and store operations. Depending upon the instruction encoding scheme used, the amount of available application memory, as well as the size, number, and configuration of available tiles varies.

FIG. 1B illustrates an embodiment of configured tiles. As shown, 4 kB of application memory 122 have stored thereon 2 pairs of 1 kB-titles, the first pair being tile t4L 124 and tile t4R 126, and the second pair being tile t5L 128 and tile t5R 130. As shown the pairs of tiles are divided into a left tile and a right tile. In other embodiments, the pair of tiles are divided into an even tile and an odd tile. In this example, the 4 tiles each have elements arranged in rows and columns. Tile t4L 124 and tile t4R 126 have K rows and N columns of 4-byte elements (e.g., single precision floating-point data), where K equals 8 and N equals 32. Tile t5L 128 and tile t5R 130 have K rows and N/2 columns of 8-byte elements (e.g., double precision floating-point data). As the double precision operands are twice the width of single precision, this configuration is consistent with a palette, used to provide tile options, supplying at least 2 names with total storage of at least 4 kB. The four tiles of FIG. 1A use 4 names, each naming a 1 kB tile, whereas the 2 pairs of tiles in FIG. 1B can use 2 names to specify the paired tiles. In some embodiments, tile instructions accept a name of a paired tile as an operand. In operation, the tiles can be loaded from and stored to memory using load and store operations. Depending upon the instruction encoding scheme used, the amount of available application memory, as well as the size, number, and configuration of available tiles varies.

In some embodiments, tile parameters are definable. For example, a “palette” is used to provide tile options. Exemplary options include, but are not limited to the number of tile names, the number of bytes in a row of storage, the number of rows and columns in a tile, etc. For example, a maximum “height” (number of rows) of a tile may be defined as: Tile Max Rows=Architected Storage/(The Number of Palette Names*The Number of Bytes per row).

As such, an application can be written such that a fixed usage of names will be able to take advantage of different storage sizes across implementations.

Configuration of tiles is done using a matrix (tile) configuration (“TILECONFIG”) instruction, where a particular tile usage is defined in a selected palette. This declaration includes the number of tile names to be used, the requested number of rows and columns per name (tile), and, in some embodiments, the requested datatype of each tile. In some embodiments, consistency checks are performed during the execution of a TILECONFIG instruction to determine that it matches the restrictions of the palette entry.

### Exemplary Tile Storage Types

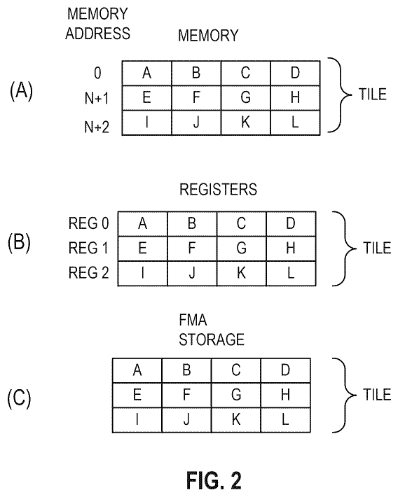

FIG. 2 illustrates several examples of matrix storage. In (A), a tile is stored in memory. As shown, each “row” consists of four packed data elements. To get to the next “row,” a stride value is used. Note that rows may be consecutively stored in memory. Strided memory accesses allow for access of one row to then next when the tile storage does not map the underlying memory array row width.

Tile loads from memory and stores to memory are typically strided accesses from the application memory to packed rows of data. Exemplary TILELOAD and TILESTORE instructions, or other instruction references to application memory as a TILE operand in load-op instructions, are, in some embodiments, restartable to handle (up to) 2*rows of page faults, unmasked floating-point exceptions, and/or interrupts per instruction.

In (B), a matrix is stored in a tile comprised of a plurality of registers such as packed data registers (single instruction, multiple data (SIMD) or vector registers). In this example, the tile is overlaid on three physical registers. Typically, consecutive registers are used, however, this need not be the case.

In (C), a matrix is stored in a tile in non-register storage accessible to a fused multiple accumulate (FMA) circuit used in tile operations. This storage may be inside of an FMA, or adjacent to it. Additionally, in some embodiments, discussed below, the storage may be for a data element and not an entire row or tile.

The supported parameters for the TMMA architecture are reported via CPUID. In some embodiments, the list of information includes a maximum height and a maximum SIMD dimension. Configuring the TMMA architecture requires specifying the dimensions for each tile, the element size for each tile and the palette identifier. This configuration is done by executing the TILECONFIG instruction.

Successful execution of a TILECONFIG instruction enables subsequent TILE operators. A TILERELEASEALL instruction clears the tile configuration and disables the TILE operations (until the next TILECONFIG instructions executes). In some embodiments, XSAVE, XSTORE, etc. are used in context switching using tiles. In some embodiments, 2 XCR0 bits are used in XSAVE, one for TILECONFIG metadata and one bit corresponding to actual tile payload data.

TILECONFIG not only configures the tile usage, but also sets a state variable indicating that the program is in a region of code with tiles configured. An implementation may enumerate restrictions on other instructions that can be used with a tile region such as no usage of an existing register set, etc.

Exiting a tile region is typically done with the TILERELEASEALL instruction. It takes no parameters and swiftly invalidates all tiles (indicating that the data no longer needs any saving or restoring) and clears the internal state corresponding to being in a tile region.

In some embodiments, tile operations will zero any rows and any columns beyond the dimensions specified by the tile configuration. For example, tile operations will zero the data beyond the configured number of columns (factoring in the size of the elements) as each row is written. For example, with 64-byte rows and a tile configured with 10 rows and 12 columns, an operation writing FP32 elements would write each of the first 10 rows with 12*4 bytes with output/result data and zero the remaining 4*4 bytes in each row. Tile operations also fully zero any rows after the first 10 configured rows. When using 1K tile with 64-byte rows, there would be 16 rows, so in this example, the last 6 rows would also be zeroed.

In some embodiments, a context restore instruction (e.g., XRSTOR), when loading data, enforces that the data beyond the configured rows for a tile will be maintained as zero. If there is no valid configuration, all rows are zeroed. XRSTOR of tile data can load garbage in the columns beyond those configured. It should not be possible for XRSTOR to clear beyond the number of columns configured because there is not an element width associated with the tile configuration.

Context save (e.g., XSAVE) exposes the entire TILE storage area when writing it to memory. If XRSTOR loaded garbage data into the rightmost part of a tile, that data will be saved by XSAVE. XSAVE will write zeros for rows beyond the number specified for each tile.

In some embodiments, tile instructions are restartable. The operations that access memory allow restart after page faults. The computational instructions that deal with floating-point operations also allow for unmasked floating-point exceptions, with the masking of the exceptions controlled by a control and/or status register.

To support restarting instructions after these events, the instructions store information in the start registers detailed below.

### Matrix (Tile) Operation Systems

### Exemplary Hardware Support

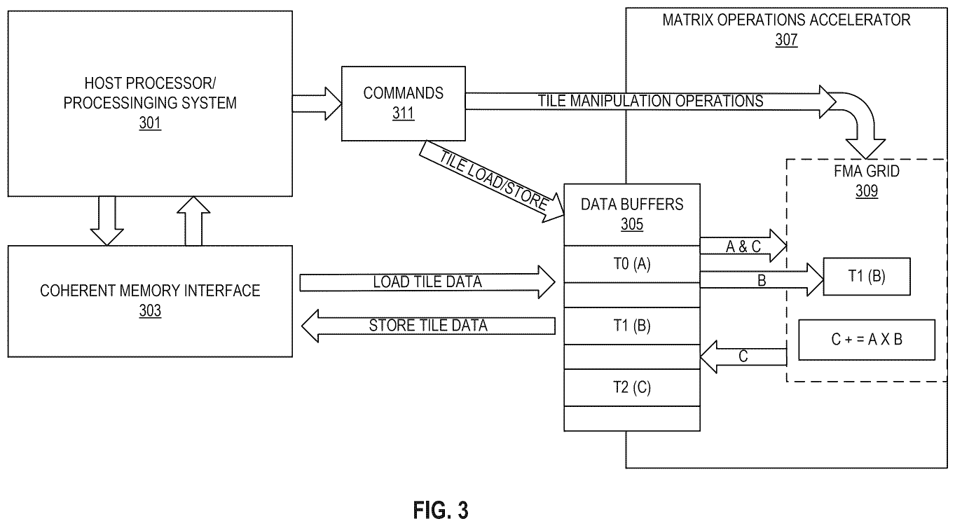

FIG. 3 illustrates an embodiment of a system utilizing a matrix (tile) operations accelerator. In this illustration, a host processor/processing system 301 communicates commands 311 (e.g., matrix manipulation operations such as arithmetic or matrix manipulation operations, or load and store operations) to a matrix operations accelerator 307. However, this is shown this way for discussion purposes only. As detailed later, this accelerator 307 may be a part of a processing core. Typically, commands 311 that are tile manipulation operator instructions will refer to tiles as register-register (“reg-reg”) or register-memory (“reg-mem”) format. Other commands such as TILESTORE, TILELOAD, TILECONFIG, etc., do not perform data operations on a tile. Commands may be decoded instructions (e.g., micro-ops) or macro-instructions for the accelerator 307 to handle.

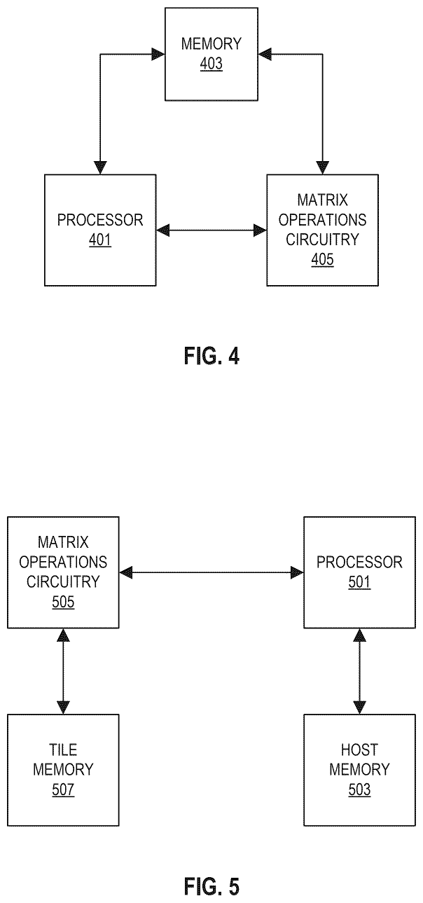

In this example, a coherent memory interface 303 is coupled to the host processor/processing system 301 and matrix operations accelerator 307 such that they can share memory. FIGS. 4 and 5 show different embodiments of how memory is shared using a matrix operations accelerator. As shown in FIG. 4, the host processor 401 and matrix operations accelerator circuitry 405 share the same memory 403. FIG. 5 illustrates an embodiment where the host processor 501 and matrix operations accelerator 505 do not share memory but can access each other's memory. For example, processor 501 can access tile memory 507 and utilize its host memory 503 as normal. Similarly, the matrix operations accelerator 505 can access host memory 503, but more typically uses its own memory 507. Note these memories may be of different types.

In some embodiments, tiles are supported using an overlay over physical registers. For example, a tile may utilize 16 1,024-bit registers, 32 512-bit registers, etc. depending on the implementation. In some embodiments, the matrix operations utilize 2-dimensional (2-D) data structures representing one or more packed regions of memory such as registers. Throughout this description, these 2-D data structures are sometimes referred to as tiles or tile registers.

In some embodiments, the matrix operations accelerator 307 includes a plurality of FMAs 309 coupled to data buffers 305 (in some implementations, one or more of these buffers 305 are stored in the FMAs of the grid as shown). The data buffers 305 buffer tiles loaded from memory and/or tiles to be stored to memory (e.g., using a tileload or tilestore instruction). Data buffers may be, for example, a plurality of registers. Typically, these FMAs are arranged as a grid of chained FMAs 309 which are able to read and write tiles. In this example, the matrix operations accelerator 307 is to perform a matrix multiply operation using tiles TO, T1, and T2. At least one of tiles is housed in the FMA grid 309. In some embodiments, all tiles in an operation are stored in the FMA grid 309. In other embodiments, only a subset is stored in the FMA grid 309. As shown, T1 is housed and TO and T2 are not. Note that A, B, and C refer to the matrices of these tiles which may or may not take up the entire space of the tile.

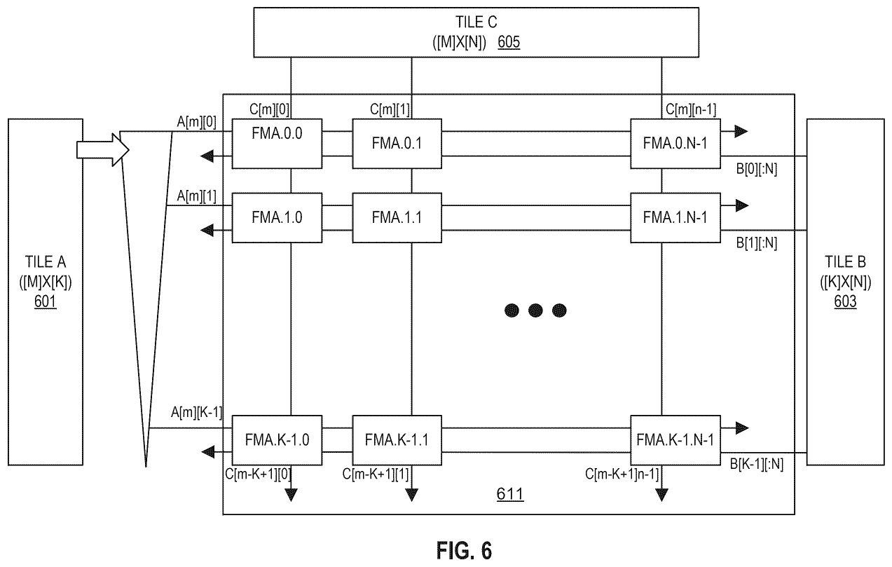

FIG. 6 illustrates an embodiment of matrix multiply accumulate operation using tiles (“TMMA”).

The number of rows in the matrix (TILE A 601) matches the number of serial (chained) FMAs comprising the computation's latency. An implementation is free to recirculate on a grid of smaller height, but the computation remains the same.

The source/destination vector comes from a tile of N rows (TILE C 605) and the grid of FMAs 611 performs N vector-matrix operations resulting in a complete instruction performing a matrix multiplication of tiles. Tile B 603 is the other vector source and supplies “broadcast” terms to the FMAs in each stage.

In operation, in some embodiments, the elements of matrix B (stored in a tile B 603) are spread across the rectangular grid of FMAs. Matrix B (stored in tile A 601) has its elements of a row transformed to match up with the columnar dimension of the rectangular grid of FMAs. At each FMA in the grid, an element of A and B are multiplied and added to the incoming summand (from above in the figure) and the outgoing sum is passed to the next row of FMAs (or the final output).

The latency of a single step is proportional to K (row height of matrix B) and dependent TMMAs typically have enough source-destination rows (either in a single tile or across tile) to hide that latency. An implementation may also split the SIMD (packed data element) dimension M (row height of matrix A) across time steps, but this simply changes the constant that K is multiplied by. When a program specifies a smaller K than the maximum enumerated by the TMACC, an implementation is free to implement this with “masking” or “early outs.”

The latency of an entire TMMA is proportional to N*K. The repeat rate is proportional to N. The number of MACs per TMMA instruction is N*K*M.

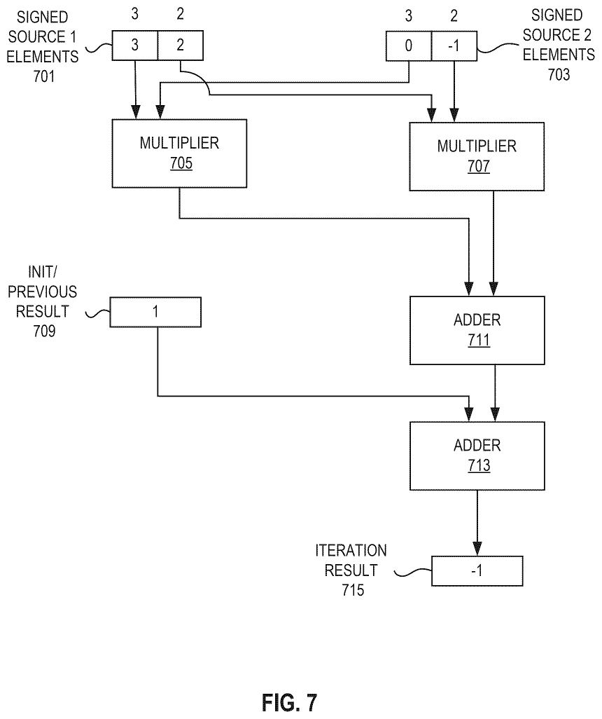

FIG. 7 illustrates an embodiment of a subset of the execution of an iteration of a chained fused multiply accumulate instruction. In particular, this illustrates execution circuitry of an iteration of one packed data element position of the destination. In this embodiment, the chained fused multiply accumulate is operating on signed sources wherein the accumulator is 2x the input data size.

A first signed source (source 1 701) and a second signed source (source 2 703) each have four packed data elements. Each of these packed data elements stores signed data such as floating-point data. A third signed source (source 3 709) has two packed data elements, each of which stores signed data. The sizes of the first and second signed sources 701 and 703 are half that of the third signed source (initial value or previous result) 709. For example, the first and second signed sources 701 and 703 could have 32-bit packed data elements (e.g., single precision floating-point) while the third signed source 709 could have 64-bit packed data elements (e.g., double precision floating-point).

In this illustration, only the two most significant packed data element positions of the first and second signed sources 701 and 703 and the most significant packed data element position of the third signed source 709 are shown. Of course, the other packed data element positions would also be processed.

As illustrated, packed data elements are processed in pairs. For example, the data of the most significant packed data element positions of the first and second signed sources 701 and 703 are multiplied using a multiplier circuit 705, and the data from second most significant packed data element positions of the first and second signed sources 701 and 703 are multiplied using a multiplier circuit 707. In some embodiments, these multiplier circuits 705 and 707 are reused for other packed data elements positions. In other embodiments, additional multiplier circuits are used so that the packed data elements are processed in parallel. In some contexts, parallel execution is done using lanes that are the size of the signed third source 709. The results of each of the multiplications are added using addition circuitry 711.

The result of the addition of the results of the multiplications is added to the data from most significant packed data element position of the signed source 3 709 (using a different adder 713 or the same adder 711).

Finally, the result of the second addition is either stored into the signed destination 715 in a packed data element position that corresponds to the packed data element position used from the signed third source 709 or passed on to the next iteration if there is one. In some embodiments, a writemask is applied to this storage such that if a corresponding writemask (bit) is set, the storage happens, and, if not set, the storage does not happen.

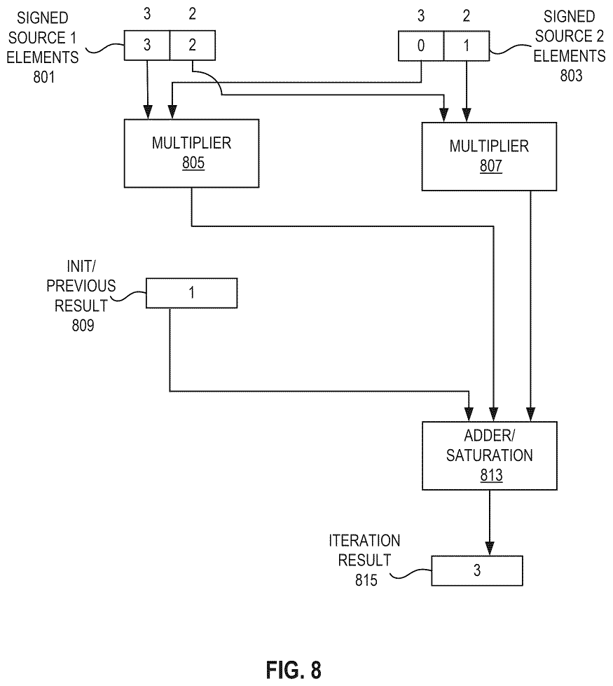

FIG. 8 illustrates an embodiment of a subset of the execution of an iteration of a chained fused multiply accumulate instruction. In particular, this illustrates execution circuitry of an iteration of one packed data element position of the destination. In this embodiment, the chained fused multiply accumulate is operating on signed sources wherein the accumulator is 2x the input data size.

A first signed source (source 1 801) and a second signed source (source 2 803) each have four packed data elements. Each of these packed data elements stores signed data such as integer data. A third signed source (source 3 809) has two packed data elements, each of which stores signed data. The sizes of the first and second signed sources 801 and 803 are half that of the third signed source 809. For example, the first and second signed sources 801 and 803 could have 32-bit packed data elements (e.g., single precision floating-point) the third signed source 809 could have 64-bit packed data elements (e.g., double precision floating-point).

In this illustration, only the two most significant packed data element positions of the first and second signed sources 801 and 803 and the most significant packed data element position of the third signed source 809 are shown. Of course, the other packed data element positions would also be processed.

As illustrated, packed data elements are processed in pairs. For example, the data of the most significant packed data element positions of the first and second signed sources 801 and 803 are multiplied using a multiplier circuit 805, and the data from second most significant packed data element positions of the first and second signed sources 801 and 803 are multiplied using a multiplier circuit 807. In some embodiments, multiplier circuits 805 and 807 perform the multiplications with infinite precision without saturation and use adder/saturation circuitry 813 to saturate the results of the accumulation to plus or minus infinity in case of an overflow and to zero in case of any underflow. In other embodiments, multiplier circuits 805 and 807 perform the saturation themselves. In some embodiments, these multiplier circuits 805 and 807 are reused for other packed data element positions. In other embodiments, additional multiplier circuits are used so that the packed data elements are processed in parallel. In some contexts, parallel execution is done using lanes that are the size of the signed third source (initial value or previous iteration result) 809. The results of each of the multiplications are added to the signed third source 809 using addition/saturation circuitry 813.

Addition/saturation (accumulator) circuitry 813 preserves a sign of an operand when the addition results in a value that is too big. In particular, saturation evaluation occurs on the infinite precision result between the multi-way-add and the write to the destination or next iteration. When the accumulator 813 is floating-point and the input terms are integer, the sum of products and the floating-point accumulator input value are turned into infinite precision values (fixed point numbers of hundreds of bits), the addition of the multiplication results and the third input is performed, and a single rounding to the actual accumulator type is performed.

Unsigned saturation means the output values are limited to a maximum unsigned number for that element width (all 1s). Signed saturation means a value is limited to the be in the range between a minimum negative number and a max positive number for that element width (for bytes for example, the range is from −128 (=−2\hat{ }7) to 127(=2\hat{ }7−1)).

The result of the addition and saturation check is stored into the signed result 815 in a packed data element position that corresponds to the packed data element position used from the signed third source 809 or passed on to the next iteration if there is one. In some embodiments, a writemask is applied to this storage such that if a corresponding writemask (bit) is set, the storage happens, and, if not set, the storage does not happen.

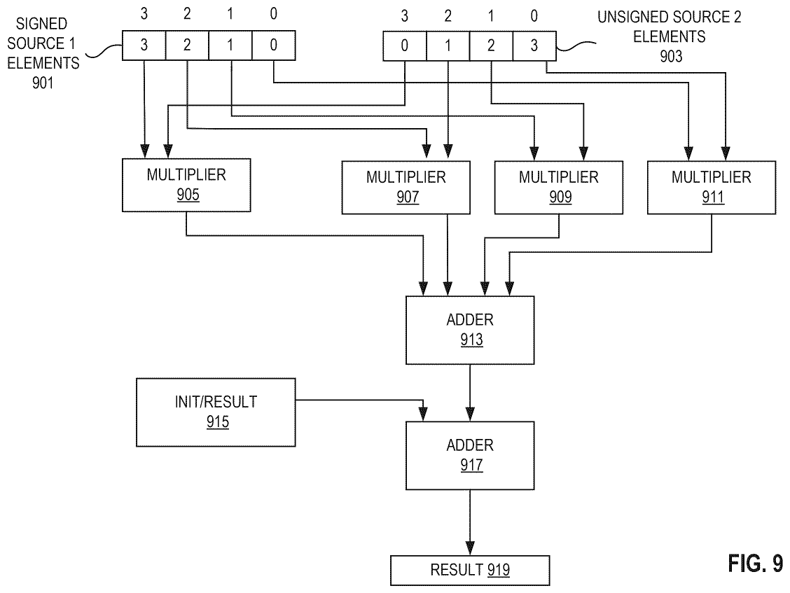

FIG. 9 illustrates an embodiment of a subset of the execution of an iteration of a chained fused multiply accumulate instruction. In particular, this illustrates execution circuitry of an iteration of one packed data element position of the destination. In this embodiment, the chained fused multiply accumulate is operating on a signed source and an unsigned source wherein the accumulator is 4× the input data size.

A first signed source (source 1 901) and a second unsigned source (source 2 903) each have four packed data elements. Each of these packed data elements has data such as floating-point or integer data. A third signed source (initial value or result 915) has a packed data element which stores signed data. The sizes of the first and second sources 901 and 903 are a quarter of the third signed source 915. For example, the first and second sources 901 and 903 could have 16-bit packed data elements (e.g., word) and the third signed source 915 could have 64-bit packed data elements (e.g., double precision floating-point or 64-bit integer).

In this illustration, the four most significant packed data element positions of the first and second sources 901 and 903 and the most significant packed data element position of the third signed source 915 are shown. Of course, other packed data element positions would also be processed if there are any.

As illustrated, packed data elements are processed in quadruplets. For example, the data of the most significant packed data element positions of the first and second sources 901 and 903 are multiplied using a multiplier circuit 905, data from second most significant packed data element positions of the first and second sources 901 and 903 are multiplied using a multiplier circuit 907, data from third most significant packed data element positions of the first and second sources 901 and 903 are multiplied using a multiplier circuit 909, and data from the least significant packed data element positions of the first and second sources 901 and 903 are multiplied using a multiplier circuit 911. In some embodiments, the signed packed data elements of the first source 901 are sign extended and the unsigned packed data elements of the second source 903 are zero extended prior to the multiplications.

In some embodiments, these multiplier circuits 905-911 are reused for other packed data elements positions. In other embodiments, additional multiplier circuits are used so that the packed data elements are processed in parallel. In some contexts, parallel execution is done using lanes that are the size of the signed third source 915. The results of each of the multiplications are added using addition circuitry 913.

The result of the addition of the results of the multiplications is added to the data from most significant packed data element position of the signed source 3 915 (using a different adder 917 or the same adder 913).

Finally, the result 919 of the second addition is either stored into the signed destination in a packed data element position that corresponds to the packed data element position used from the signed third source 915 or passed to the next iteration. In some embodiments, a writemask is applied to this storage such that if a corresponding writemask (bit) is set, the storage happens, and, if not set, the storage does not happen.

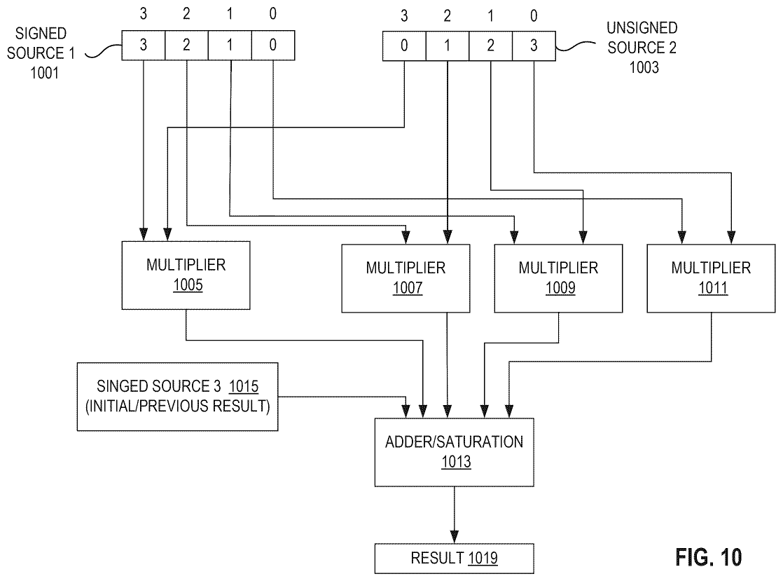

FIG. 10 illustrates an embodiment of a subset of the execution of an iteration of chained fused multiply accumulate instruction. In particular, this illustrates execution circuitry of an iteration of one packed data element position of the destination. In this embodiment, the chained fused multiply accumulate is operating on a signed source and an unsigned source wherein the accumulator is 4× the input data size.

A first signed source 1001 and a second unsigned source 1003 each have four packed data elements. Each of these packed data elements stores data such as floating-point or integer data. A third signed source 1015 (initial or previous result) has a packed data element which stores signed data. The sizes of the first and second sources are a quarter of the third signed source 1015 (initial or previous result). For example, the first and second sources could have 16-bit packed data elements (e.g., word) and the third signed source 1015 (initial or previous result) could have 64-bit packed data elements (e.g., double precision floating-point or 64-bit integer).

In this illustration, the four most significant packed data element positions of the first signed source 1001 and the second unsigned source 1003 and the most significant packed data element position of the third signed source 1015 are shown. Of course, other packed data element positions would also be processed if there are any.

As illustrated, packed data elements are processed in quadruplets. For example, the data of the most significant packed data element positions of the first signed source 1001 and the second unsigned source 1003 are multiplied using a multiplier circuit 1005, data from second most significant packed data element positions of the first signed source 1001 and the second unsigned source 1003 are multiplied using a multiplier circuit 1007, data from third most significant packed data element positions of the first signed source 1001 and the second unsigned source 1003 are multiplied using a multiplier circuit 1009, and data from the least significant packed data element positions of the first signed source 1001 and the second unsigned source 1003 are multiplied using a multiplier circuit 1011. In some embodiments, the signed packed data elements of the first signed source 1001 are sign extended and the unsigned packed data elements of the second unsigned source 1003 are zero extended prior to the multiplications.

In some embodiments, these multiplier circuits 1005-1011 are reused for other packed data elements positions. In other embodiments, additional multiplier circuits are used so that the packed data elements are processed in parallel. In some contexts, parallel execution is done using lanes that are the size of third signed source 1015 (initial or previous result). The result of the addition of the results of the multiplications is added to the data from most significant packed data element position of third signed source 1015 (initial or previous result) using adder/saturation 1013 circuitry.

Addition/saturation (accumulator) circuitry 1013 preserves a sign of an operand when the addition results in a value that is too big or too small for signed saturation. In particular, saturation evaluation occurs on the infinite precision result between the multi-way-add and the write to the destination. When the accumulator 1013 is floating-point and the input terms are integer, the sum of products and the floating-point accumulator input value are turned into infinite precision values (fixed point numbers of hundreds of bits), the addition of the multiplication results and the third input is performed, and a single rounding to the actual accumulator type is performed.

The result 1019 of the addition and saturation check is stored into the signed destination in a packed data element position that corresponds to the packed data element position used from third signed source 1015 (initial or previous result) or passed to the next iteration. In some embodiments, a writemask is applied to this storage such that if a corresponding writemask (bit) is set, the storage happens, and, if not set, the storage does not happen.

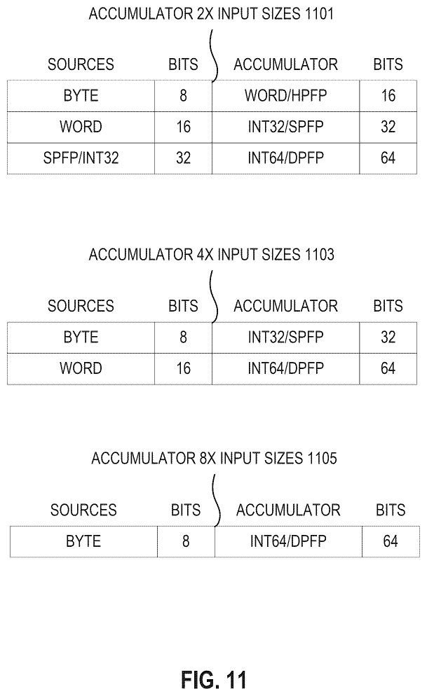

FIG. 11 illustrates power-of-two sized SIMD implementations wherein the accumulators use input sizes that are larger than the inputs to the multipliers according to an embodiment. Note the source (to the multipliers) and accumulator values may be signed or unsigned values. For an accumulator having 2× input sizes (in other words, the accumulator input value is twice the size of the packed data element sizes of the sources), table 1101 illustrates different configurations. For byte sized sources, the accumulator uses word or half-precision floating-point (HPFP) values that are 16-bit in size. For word sized sources, the accumulator uses 32-bit integer or single-precision floating-point (SPFP) values that are 32-bit in size. For SPFP or 32-bit integer sized sources, the accumulator uses 64-integer or double-precision floating-point (DPFP) values that are 64-bit in size.

For an accumulator having 4× input sizes (in other words, the accumulator input value is four times the size of the packed data element sizes of the sources), table 1103 illustrates different configurations. For byte sized sources, the accumulator uses 32-bit integer or single-precision floating-point (SPFP) values that are 32-bit in size. For word sized sources, the accumulator uses 64-bit integer or double-precision floating-point (DPFP) values that are 64-bit in size in some embodiments.

For an accumulator having 8× input sizes (in other words, the accumulator input value is eight times the size of the packed data element sizes of the sources), table 1105 illustrates a configuration. For byte sized sources, the accumulator uses 64-bit integer.

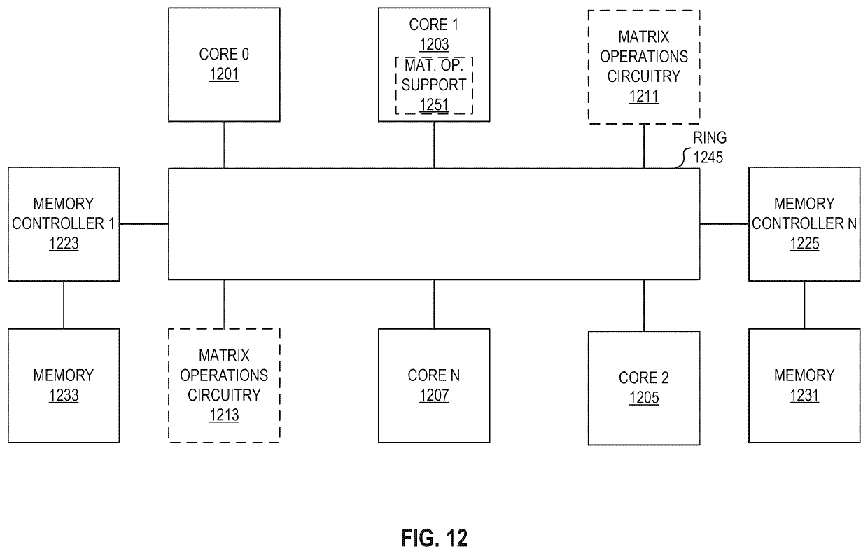

As hinted at earlier, matrix operations circuitry may be included in a core, or as an external accelerator. FIG. 12 illustrates an embodiment of a system utilizing matrix operations circuitry. In this illustration, multiple entities are coupled with a ring interconnect 1245.

A plurality of cores, core 0 1201, core 1 1203, core 2 1205, and core N 1207 provide non-tile-based instruction support. In some embodiments, matrix operations circuitry 1251 is provided in a core 1203, and in other embodiments matrix operations circuitries 1211 and 1213 are accessible on the ring interconnect 1245.

Additionally, one or more memory controllers 1223-1225 are provided to communicate with memory 1233 and 1231 on behalf of the cores and/or matrix operations circuitry.

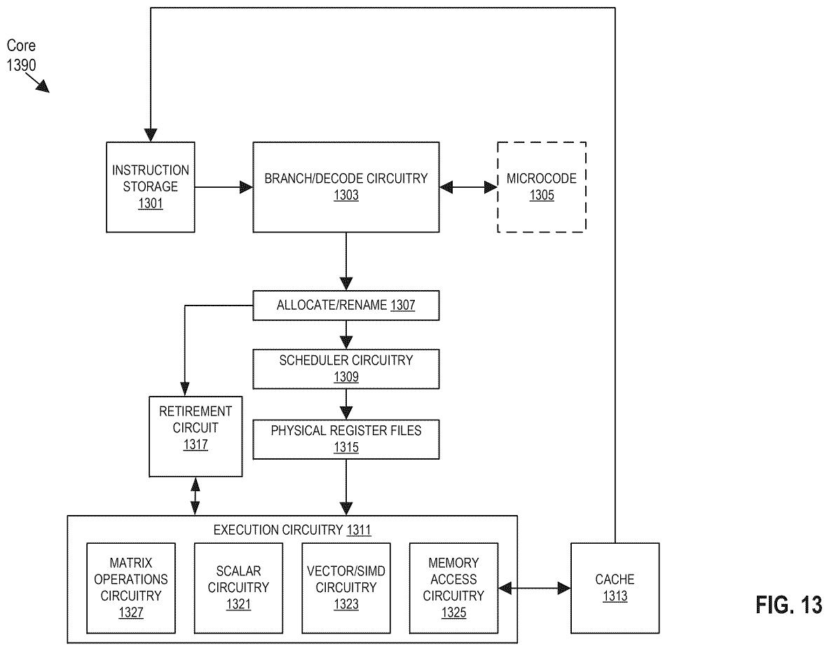

FIG. 13 illustrates an embodiment of a processor core pipeline supporting matrix operations using tiles. Branch prediction and decode circuitry 1303 performs branch predicting of instructions, decoding of instructions, and/or both from instructions stored in instruction storage 1301. For example, instructions detailed herein may be stored in instruction storage. In some implementations, separate circuitry is used for branch prediction and in some embodiments, at least some instructions are decoded into one or more micro-operations, micro-code entry points, microinstructions, other instructions, or other control signals using microcode 1305. The branch prediction and decode circuitry 1303 may be implemented using various different mechanisms. Examples of suitable mechanisms include, but are not limited to, look-up tables, hardware implementations, programmable logic arrays (PLAs), microcode read only memories (ROMs), etc.

The branch prediction and decode circuitry 1303 is coupled to allocate/rename 1307 circuitry which is coupled, in some embodiments, to scheduler circuitry 1309. In some embodiments, these circuits provide register renaming, register allocation, and/or scheduling functionality by performing one or more of: 1) renaming logical operand values to physical operand values (e.g., a register alias table in some embodiments), 2) allocating status bits and flags to the decoded instruction, and 3) scheduling the decoded instruction for execution on execution circuitry out of an instruction pool (e.g., using a reservation station in some embodiments).

The scheduler circuitry 1309 represents any number of different schedulers, including reservations stations, central instruction window, etc. The scheduler circuitry 1309 is coupled to, or includes, physical register file(s) 1315. Each of the physical register file(s) 1315 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), tiles, etc. In one embodiment, the physical register file(s) 1315 comprises vector registers circuitry, write mask registers circuitry, and scalar registers circuitry. These register circuits may provide architectural vector registers, vector mask registers, and general-purpose registers. The physical register file(s) 1315 is overlapped by a retirement circuit 1317 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1317 and the physical register file(s) 1315 are coupled to the execution circuitry 1311.

While register renaming is described in the context of out-of-order execution, it should be understood that register renaming may be used in an in-order architecture. While the illustrated embodiment of the processor may also include separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

The execution circuitry 1311 is a set of one or more execution circuits, including scalar circuitry 1321, vector/SIMD circuitry 1323, and matrix operations circuitry 1327, as well as memory access circuitry 1325 to access cache 1313. The execution circuits perform various operations (e.g., shifts, addition, subtraction, multiplication) and on various types of data (e.g., scalar floating-point, packed integer, packed floating-point, vector integer, vector floating-point). While some embodiments may include a number of execution units dedicated to specific functions or sets of functions, other embodiments may include only one execution unit or multiple execution units that all perform all functions. The scalar circuitry 1321 performs scalar operations, the vector/SIMD circuitry 1323 performs vector/SIMD operations, and matrix operations circuitry 1327 performs matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1303 performs a decode stage; 3) the allocate/rename 1307 circuitry performs an allocation stage and renaming stage; 4) the scheduler circuitry 1309 performs a schedule stage; 5) physical register file(s) (coupled to, or included in, the scheduler circuitry 1309 and allocate/rename 1307 circuitry and a memory unit perform a register read/memory read stage; the execution circuitry 1311 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 1390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

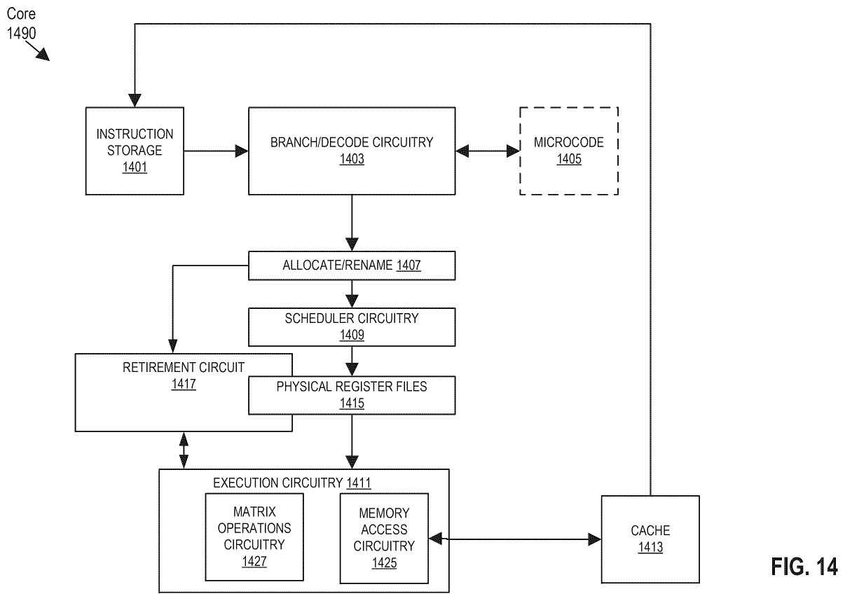

FIG. 14 illustrates an embodiment of a processor core pipeline supporting matrix operations using tiles. Branch prediction and decode circuitry 1403 performs branch predicting of instructions, decoding of instructions, and/or both from instructions stored in instruction storage 1401. For example, instructions detailed herein may be stored in instruction storage. In some implementations, separate circuitry is used for branch prediction and in some embodiments, at least some instructions are decoded into one or more micro-operations, micro-code entry points, microinstructions, other instructions, or other control signals using microcode 1405. The branch prediction and decode circuitry 1403 may be implemented using various different mechanisms. Examples of suitable mechanisms include, but are not limited to, look-up tables, hardware implementations, programmable logic arrays (PLAs), microcode read only memories (ROMs), etc.

The branch prediction and decode circuitry 1403 is coupled to allocate/rename 1407 circuitry which is coupled, in some embodiments, to scheduler circuitry 1409. In some embodiments, these circuits provide register renaming, register allocation, and/or scheduling functionality by performing one or more of: 1) renaming logical operand values to physical operand values (e.g., a register alias table in some embodiments), 2) allocating status bits and flags to the decoded instruction, and 3) scheduling the decoded instruction for execution on execution circuitry out of an instruction pool (e.g., using a reservation station in some embodiments).

The scheduler circuitry 1409 represents any number of different schedulers, including reservations stations, central instruction window, etc. The scheduler unit(s) scheduler circuitry 1409 is coupled to, or includes, physical register file(s) 1415. Each of the physical register file(s) 1415 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), tiles, etc. In one embodiment, the physical register file(s) 1415 comprises vector registers circuitry, write mask registers circuitry, and scalar registers circuitry. These register circuits may provide architectural vector registers, vector mask registers, and general-purpose registers. The physical register file(s) 1415 is overlapped by a retirement circuit 1417 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1417 and the physical register file(s) 1415 are coupled to the execution circuitry 1411.

While register renaming is described in the context of out-of-order execution, it should be understood that register renaming may be used in an in-order architecture. While the illustrated embodiment of the processor may also include separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

The execution circuitry 1411 a set of one or more execution circuits 1427 and a set of one or more memory access circuits 1425 to access cache 1413. The execution circuits 1427 perform matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1403 performs a decode stage; 3) the allocate/rename 1407 circuitry performs an allocation stage and renaming stage; 4) the scheduler circuitry 1409 performs a schedule stage; 5) physical register file(s) (coupled to, or included in, the scheduler circuitry 1409 and allocate/rename 1407 circuitry and a memory unit perform a register read/memory read stage; the execution circuitry 1411 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 1490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

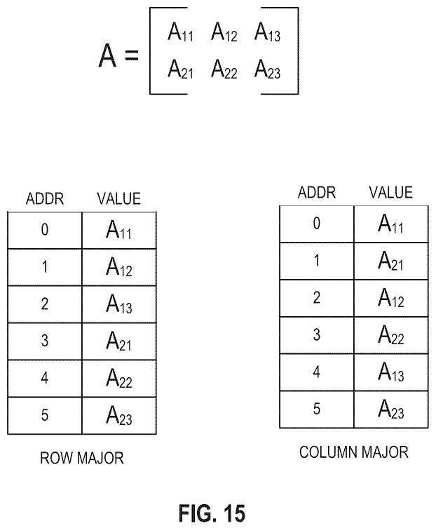

Throughout this description, data is expressed using row major data layout. Column major users should translate the terms according to their orientation. FIG. 15 illustrates an example of a matrix expressed in row major format and column major format. As shown, matrix A is a 2×3 matrix. When this matrix is stored in row major format, the data elements of a row are consecutive. When this matrix is stored in column major format, the data elements of a column are consecutive. It is a well-known property of matrices that AT*BT=(BA) T, where superscript T means transform. Reading column major data as row major data results in the matrix looking like the transform matrix.

In some embodiments, row-major semantics are utilized in hardware, and column major data is to swap the operand order with the result being transforms of matrix, but for subsequent column-major reads from memory it is the correct, non-transformed matrix. For example, if there are two column-major matrices to multiply:

| a b | g i k | ag + bh ai + bj ak + bl |
|---|---|---|
| c d * | h j l = | cg + dh ci + dj ck + dl |
| e f | | eg + fh ei + fj ek + fl |
| (3 × 2) | (2 × 3) | (3 × 3) |

The input matrices would be stored in linear memory (column-major) as:

a c e b d f
and
g h i j k l.

Reading those matrices as row-major with dimensions 2×3 and 3×2, they would appear as:

| | | |
|---|---|---|
| a c e | and | g h |
| b d f | | i j |
| k l | | |

Swapping the order and matrix multiplying:

| | | |
|---|---|---|
| g h | a c e | ag + bh cg + dh eg + fh |
| i j * | b d f = | ai + bj ci + dj ei + fj |
| k l | | ak + bl ck + dl ek + fl |

The transform matrix is out and can then be stored in in row-major order:

ag + bh cg + dh eg + fh ai + bj ci + dj ei + fj ak + bl ck + dl ek + fl

and used in subsequent column major computations, it is the correct un-transformed matrix:

| | | |
|---|---|---|
| ag + bh | ai + bj | ak + bl |
| cg + dh | ci + dj | ck + dl |
| eg + fh | ei + fj | ek + fl |

### Exemplary Usage

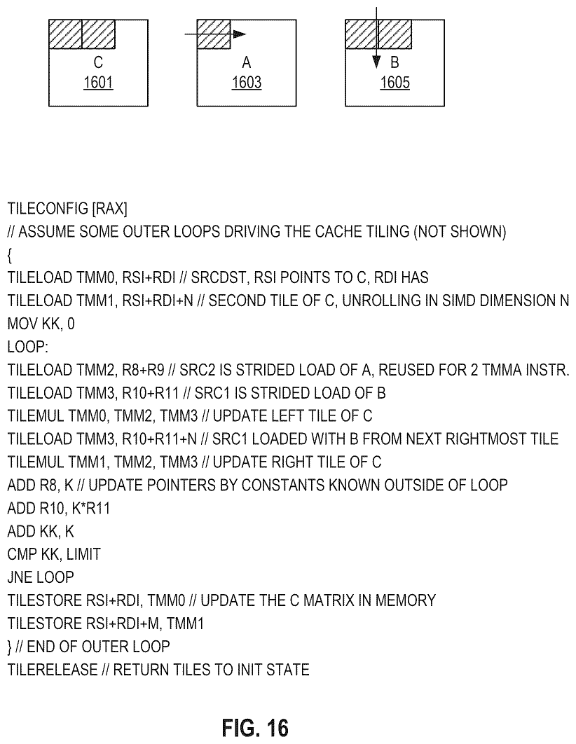

FIG. 16 illustrates an example of usage of matrices (tiles). In this example, matrix C 1601 includes two tiles, matrix A 1603 includes one tile, and matrix B 1605 includes two tiles. This figure shows an example of the inner loop of an algorithm to compute a matrix multiplication. In this example, two result tiles, tmm0 and tmm1, from matrix C 1601 are used to accumulate the intermediate results. One tile from the matrix A 1603 (tmm2) is re-used twice as it multiplied by two tiles from matrix B 1605. Pointers to load a new A matrix (tile) and two new B matrices (tiles) from the directions indicated by the arrows. An outer loop, not shown, adjusts the pointers for the C tiles.

The exemplary code as shown includes the usage of a tile configuration instruction and is executed to configure tile usage, load tiles, a loop to process the tiles, store tiles to memory, and release tile usage.

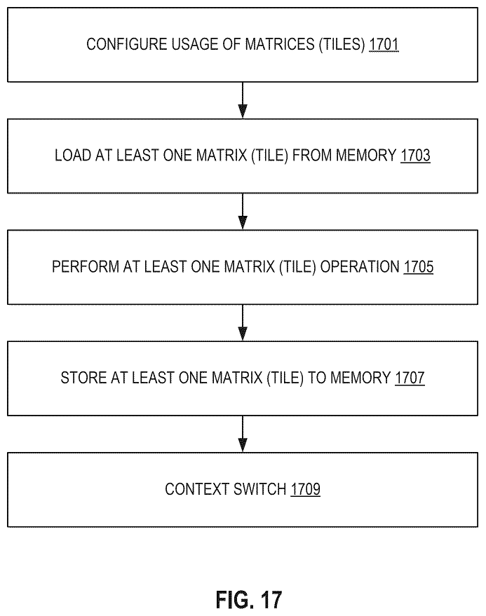

FIG. 17 illustrates an embodiment of usage of matrices (tiles). At 1701, tile usage is configured. For example, a TILECONFIG instruction is executed to configure tile usage including setting a number of rows and columns per tile. Typically, at least one matrix (tile) is loaded from memory at 1703. At least one matrix (tile) operation is performed at 1705 using the matrices (tiles). At 1707, at least one matrix (tile) is stored out to memory and a context switch can occur at 1709.

### Exemplary Configuration

### Tile Configuration Hardware Support

As discussed above, tile usage typically needs to be configured prior to use. For example, full usage of all rows and columns may not be needed. Not only does not configuring these rows and columns save power in some embodiments, but the configuration may be used to determine if an operation will generate an error. For example, a matrix multiplication of the form (N×M)*(L×N) will typically not work if M and L are not the same.

Prior to using matrices using tiles, in some embodiments, tile support is to be configured. For example, how many rows and columns per tile, tiles that are to be used, etc. are configured. A TILECONFIG instruction is an improvement to a computer itself as it provides support to configure the computer to use a matrix accelerator (either as a part of a processor core, or as an external device). In particular, an execution of the TILECONFIG instruction causes a configuration to be retrieved from memory and applied to matrix (tile) settings within a matrix accelerator.

### Tile Usage Configuration

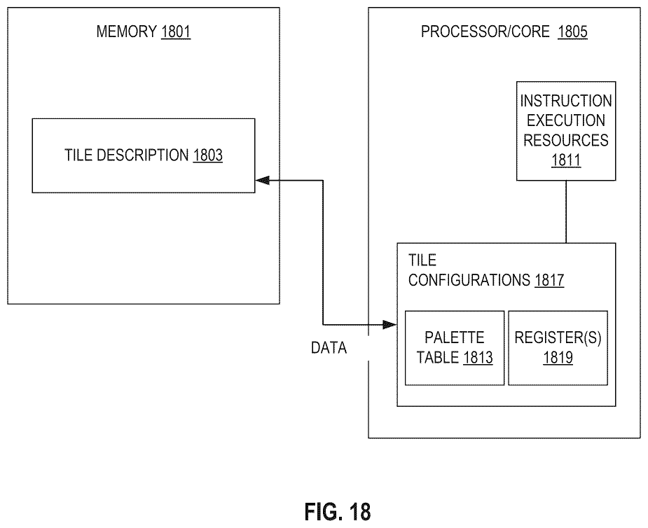

FIG. 18 illustrates support for configuration of the usage of tiles according to an embodiment. A memory 1801 contains the tile description 1803 of the matrices (tiles) to be supported.

Instruction execution resources 1811 of a processor/core 1805 stores aspects of a tile description 1803 into tile configurations 1817. The tile configurations 1817 include palette table 1813 to detail what tiles for a palette are configured (the number of rows and columns in each tile) and a marking that matrix support is in use. In particular, instruction execution resources 1811 are configured to use tiles as specified by the tile configurations 1817. The instruction execution resources 1811 may also include a machine specific register or configuration register to indicate tile usage. Additional values such as in-use and start values are also set. The tile configurations 1817 utilize register(s) 1819 to store tile usage and configuration information.

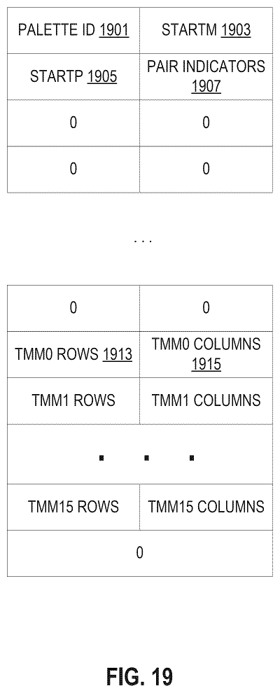

FIG. 19 illustrates an embodiment of a description of the matrices (tiles) to be supported. This is the description that is to be stored upon an execution of a STTILECFG instruction. In this example, each field is a byte. In byte [0], a palette ID 1901 is stored. The palette ID is used to index a palette table 1813 which stores, per palette ID, a number of bytes in a tile, and bytes per row of the tiles that are associated with this ID as defined by the configuration.

Byte 1 stores a value to be stored in a “startRow” register 1903 and byte 2 stores a value to be stored in a register, startP 1905. To support restarting instructions after these events, the instructions store information in these registers. To support restarting instructions after break events such as those detailed above, the instructions store information in these registers. The startRow value indicates the row that should be used for restart. The startP value indicates the position within the row for store operations when pairs are used and, in some embodiments, indicates the lower half of the row (in the lower tile of a pair) or higher half of the row (in the higher tile of a pair). Generally, the position in the row (the column) is not needed.

With the exception of TILECONFIG and STTILECFG, successfully executing matrix (tile) instructions will set both startRow and startP to zero.

Any time an interrupted matrix (tile) instruction is not restarted, it is the responsibility of software to zero the startRow and startP values. For example, unmasked floating-point exception handlers might decide to finish the operation in software and change the program counter value to another instruction, usually the next instruction. In this case the software exception handler must zero the startRow and startP values in the exception presented to it by the operating system before resuming the program. The operating system will subsequently reload those values using a restore instruction.

Byte 3 stores an indication of pairs (1 b per tile) of tiles 1907.

Bytes 16-17 store the number of rows 1913 and columns 1915 for tile 0, bytes 18-19 store the number of rows and columns for tile 1, etc. In other words, each 2-byte group specifies a number of rows and columns for a tile. If a group of 2 bytes is not used to specify tile parameters, they should have the value zero. Specifying tile parameters for more tiles than the implementation limit or the palette limit results in a fault. Unconfigured tiles are set to an initial state with 0 rows, 0 columns.

Finally, the configuration in memory typically ends with an ending delineation such as all zeros for several consecutive bytes.

### Exemplary Tile and Tile Configuration Storage

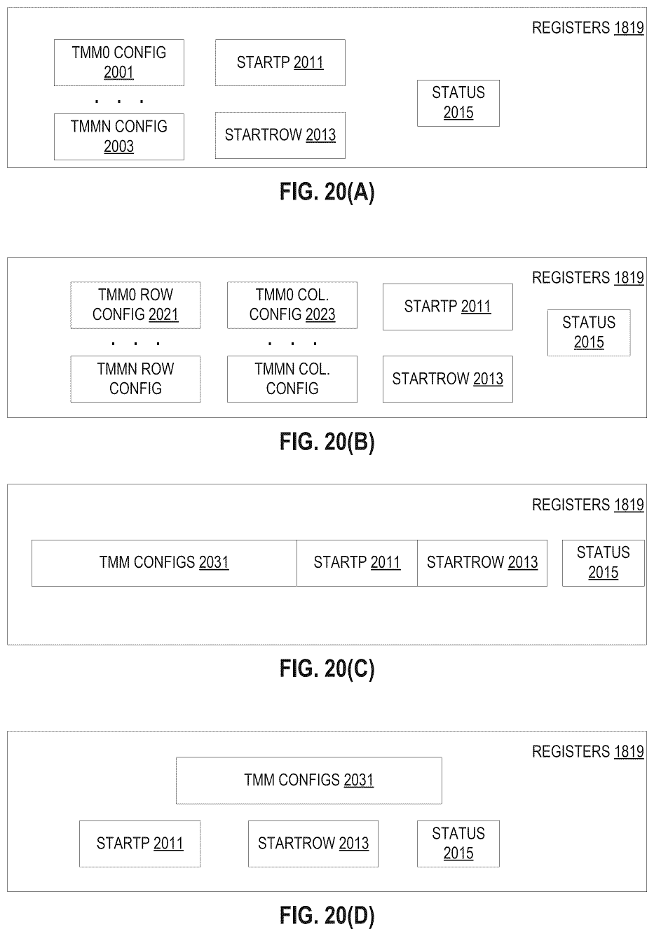

FIGS. 20(A)-(D) illustrate examples of register(s) 1819. FIG. 20(A) illustrates a plurality of registers 1819. As shown each tile (TMM0 2001 . . . . TMMN 2003) has a separate register with each register storing a row and column size for that particular tile. StartP 2011 and StartRow 2013 are stored in separate registers. One or more status registers 2015 are set (e.g., TILES_CONFIGURED=1) to indicate tiles are configured for use.

FIG. 20(B) illustrates a plurality of registers 1819. As shown each tile has separate registers for its rows and columns. For example, TMM0 rows configuration 2021, TMM0 columns configuration 2023, StartP 2011 and StartRow 2013 are stored in separate registers. One or more status registers 2015 are set (e.g., TILES_CONFIGURED=1) to indicate tiles are configured for use.

FIG. 20(C) illustrates a single register 1819. As shown, this register stores tile configurations (rows and columns per tile) 2031, StartP 2011, and StartRow 2013 are stored in single register as packed data registers. One or more status registers 2015 are set (e.g., TILES_CONFIGURED=1) to indicate tiles are configured for use.

FIG. 20(D) illustrates a plurality of registers 1819. As shown, a single register stores tile configuration (rows and columns per tile) 2031. StartP and StartRow are stored in separate registers 2011 and 2013. One or more status registers 2015 are set (e.g., TILECONFIGURED=1) to indicate tiles are configured for use.

Other combinations are contemplated such as combining the start registers into a single register where they are shown separately, etc.

### Silent Data Reduction Using Redundancy

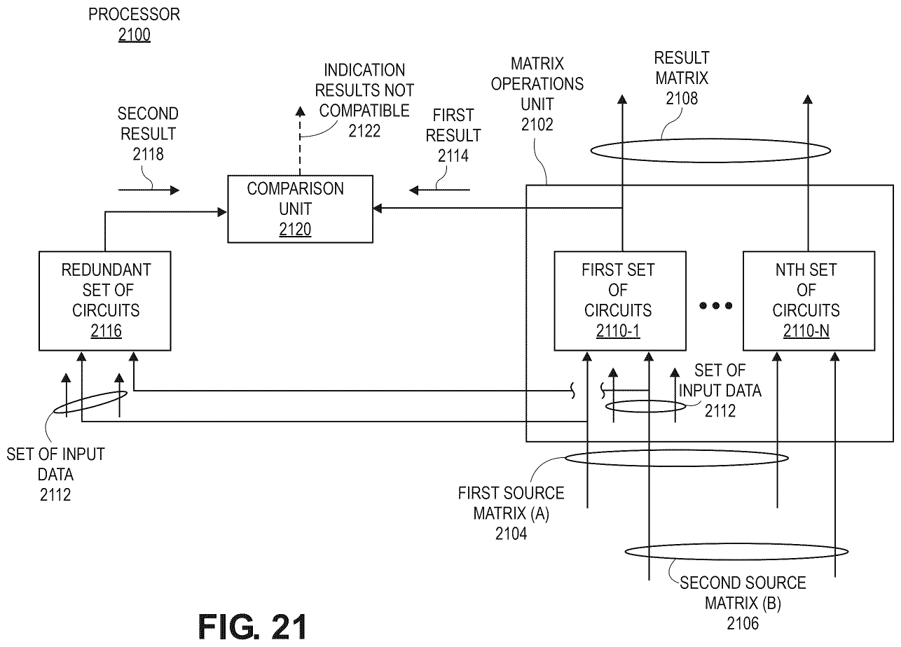

FIG. 21 is a block diagram of an embodiment of a processor 2100. In some embodiments, the processor may be a general-purpose processor (e.g., a general-purpose microprocessor or central processing unit (CPU) of the type used in desktop, laptop, server, smartphone, or other computers). Alternatively, the processor may be a special-purpose processor. Examples of suitable special-purpose processors include, but are not limited to, graphics processors (e.g., graphics processing units (GPUs)), machine learning processors, artificial intelligence processors, cryptographic processors, co-processors, various types of accelerators, embedded processors, digital signal processors (DSPs), and controllers (e.g., microcontrollers). The processor may have any of various complex instruction set computing (CISC) architectures, reduced instruction set computing (RISC) architectures, very long instruction word (VLIW) architectures, hybrid architectures, other types of architectures, or have a combination of different architectures. In some embodiments, the processor may include (e.g., be disposed on) at least one integrated circuit and/or semiconductor die.

The processor includes a matrix operations unit 2102. Examples of suitable matrix operations units include, but are not limited to, matrix multiplication units, tile multiplication units, tensor processing units (TPUs), tensor cores, matrix accelerators, matrix engines, artificial intelligence engines, artificial intelligence accelerators, and the like. One specific example of a suitable matrix operations unit is the tile matrix multiplication (TMUL) unit used in Intel® Advanced Matrix Extensions (Intel® AMX).

The matrix operations unit is operable to perform a matrix operation on a first source matrix 2104 (e.g., also referred to as an A matrix) and a second source matrix 2106 (e.g., also referred to as a B matrix) to generate a result matrix 2108 (e.g., also referred to as a C matrix). The processor may also optionally include a buffer or other local storage (not shown) to store the first matrix, the second matrix, and the result matrix. Examples of suitable types of matrix operations include, but are not limited to, matrix multiplication (e.g., C=A*B), matrix multiplication and accumulation (e.g., Cout=Cin+A*B), multiplication of a matrix by a transposed matrix, matrix addition, matrix subtraction, matrix division, other matrix arithmetic operations, matrix logical operations, etc. In some embodiments, the matrix operation unit may be operable to perform multiple different types of matrix operations.

The matrix operations unit includes a plurality of sets of circuits 2110. In the illustrated embodiment, these include a first set of circuits 2110-1 through an Nth set of circuits 2110-N. The number N often ranges from at least eight to around a few hundred (e.g., 8, 16, 32, 64, 128), although the scope of the invention is not limited to any known number. In some embodiments, the sets of circuits are sets of multiply-add circuits. Multiply-add circuits are also sometimes referred to in the arts as multiply-accumulate circuits. For simplicity, multiply-add and multiply-accumulate circuits will often be referred to herein simply as MA circuits. Each MA circuit may include at least one multiplier (e.g., a multiplication circuit) to multiply at least two numbers to form a product and at least one adder (e.g., an addition circuit) to add a number (e.g., the product) to a third number (e.g., an accumulation value). Various MA circuit designs are suitable. In some embodiments, the MA circuits may be fused MA circuits. The term fused indicates that for floating-point data a single rounding operation may be performed after the addition rather than performing one rounding operation after the multiplication and another rounding operation after the addition. It is also possible to use non-fused multiply-add circuits and non-fused multiply-accumulate circuits for floating point data, if desired. MA circuits that operate on integer data generally are not fused. Alternatively, the sets of circuits 2110 may include other matrix operations circuitry for other matrix operations as mentioned above. For example, the sets of circuits may be sets of adder circuits, sets of arithmetic circuits, sets of logical circuits, etc.

The plurality of sets of (e.g., MA) circuits are together or collectively sufficient to perform the matrix operation (e.g., matrix multiplication with optional accumulation) on the first and second source matrices to generate the result matrix (e.g., a matrix representing a product of the first and second source matrices with optional accumulation with an accumulation matrix). In some embodiments, each of the sets of (e.g., MA) circuits may be one or more columns of (e.g., MA) circuits (e.g., a single column of MA circuits). In other embodiments, each of the sets of (e.g., MA) circuits may be one or more rows of (e.g., MA) circuits (e.g., a single row of MA circuits). In still other embodiments, each of the sets of (e.g., MA) circuits may be only a part of a single column (e.g., half a column, a quarter a column, a single circuit (or other matrix operation element) of a column, etc.) or only a part of a single row (e.g., half a row, a quarter a row, a single circuit (or other matrix operation element) of a row, etc.) of (e.g., MA) circuits. The column of circuits may represent a column of serially connected circuits. In some embodiments, the (e.g., MA) circuits are non-systolic (e.g., MA) circuits.

As previously discussed, hard errors occasionally occur in processors and other semiconductor devices. These hard errors can also cause SDEs, which may represent a significant problem. In some embodiments, the matrix operations unit may tend to be large and/or include a large amount of circuitry (e.g., since processing matrices involves a relatively large number of calculations especially when the matrices are relatively large). As a result, more hard errors and/or SDEs may tend to occur in the matrix operations unit.

Referring again to FIG. 21, the processor also includes a redundant set of circuits 2116. The redundant set of circuits are referred to as redundant because they are an additional or extra set of circuits beyond, exceeding, or in addition to the plurality of sets of circuits that are together or collectively sufficient to perform the matrix operation on the first and second source matrices to generate the result matrix. That is, the redundant set of circuits is not needed to generate the result matrix. Rather, the redundant set of circuits is an additional or extra set of circuits that is included to check, verify, mirror, mimic, or reproduce the calculations or part of the matrix operation performed by one of the plurality of sets of circuits 2110. The plurality of sets of circuits broadly represent a number of circuits or structures operating in parallel or concurrently to perform calculations. The redundant set of circuits broadly represents a redundant copy of one of the circuits or structures.

The redundant set of circuits may effectively be a replicate, duplicate, or other copy of one of the plurality of sets of circuits 2110. For example, in some embodiments, each of the sets of (e.g., MA) circuits may be one or more columns of (e.g., MA) circuits (e.g., a single column of MA circuits), and likewise the redundant set of (e.g., MA) circuits may be one or more columns of (e.g., MA) circuits (e.g., a single column of MA circuits). In other embodiments, each of the sets of (e.g., MA) circuits may be one or more rows of (e.g., MA) circuits (e.g., a single row of MA circuits), and likewise the redundant set of (e.g., MA) circuits may be one or more rows of (e.g., MA) circuits (e.g., a single row of MA circuits). In still other embodiments, each of the sets of (e.g., MA) circuits may be only a part of a single column (e.g., half a column, a quarter a column, a single circuit (or other matrix operation element of a column, etc.), and likewise the redundant set of (e.g., MA) circuits may be only a part of a single column (e.g., half a column, a quarter a column, a single circuit (or other matrix operation element) of a column, etc.). In still other embodiments, each of the sets of (e.g., MA) circuits may be only a part of a single row (e.g., half a row, a quarter a row, a single circuit (or other matrix operation element) of a row), and likewise the redundant set of (e.g., MA) circuits may be only a part of a single row (e.g., half a row, a quarter a row, a single circuit (or other matrix operation element) of a row, etc.). In one specific illustrative example embodiment, the plurality of sets of circuits may be sixteen columns of MA circuits and the redundant set of circuits may be a single column of MA circuits, although the scope of the invention is not so limited. In the illustration the redundant set of circuits is shown separated from the matrix operations unit, although in other embodiments, the redundant set of circuits may optionally be an additional set of circuits physically within or alongside the matrix operations unit (e.g., an additional column of MA circuits in an array of columns of MA circuits).

In the illustrated embodiment, one of the plurality of sets of circuits has been selected or otherwise indicated. Specifically, in this example, the first set of circuits 2110-1 has been selected or indicated. The redundant set of circuits may be used to check, verify, mirror, mimic, or reproduce the calculations performed by the selected or otherwise indicated set of circuits (e.g., in this example the first set of circuits). A set of input data 2112 is provided or input to the selected or indicated first set of circuits. The set of input data may represent a subset or portion of the first and second source matrices to be processed by the selected or indicated first set of circuits. Similarly, different sets of input data may be provided or input to the other sets of circuits. The same set of input data 2112 may also be provided or input to the redundant set of circuits. For example, in one embodiment a single row of the first source matrix and a single column of the second source matrix may be input to the indicated set of MA circuits 2110-1, and the same single row of the first source matrix and the same single column of the second source matrix may also be input to the redundant set of MA circuits. This may allow the calculations performed by the selected or indicated first set of MA circuits, and the calculations performed by the redundant set of MA circuits, to be performed on the same set of data. In such an embodiment, the calculations may include a dot product of the input row by the input column with optional accumulation with an accumulation value.

Referring again to FIG. 21, the processor also includes a comparison unit 2120. The comparison unit is coupled with the matrix operations unit. For example, the comparison unit is coupled with the selected or indicated first set of circuits to receive a first result 2118 generated by and output or provided from the selected or indicated first set of circuits based on the set of input. The comparison unit is also coupled with the redundant set of circuits to receive a second result 2114 generated by and output or provided from the redundant set of circuits based on the same set of input. The comparison unit is operative to compare the first result and the second result. The comparison of the first result and the second result is not limited to only a simple comparison for equality (e.g., if the first result equals the second result) but may include other types of comparisons, such as, for example, subtracting one of the first results from the other and determining if the result of that subtraction is zero, logically ANDing one of the first and second results with the logical NOT or inverse of the other and determining if the result is all zeroes, etc. If the calculations are free of soft errors and hard errors, the first result should equal, match, or otherwise be compatible with the second result. However, if any soft errors or hard errors have occurred during the calculations, then the first result should not equal, should not match, or should otherwise not be compatible with the second result. Compatibility may also be assessed through other operations than testing for equality, such as, for example, by determining whether subtraction of one from the other results in zero, by determining whether a logical AND of one with the logical NOT of the other is all zeroes, etc. Note that this is not a check of whether the first result is mathematically correct, but rather is a check of whether the selected or indicated first set of circuits and the redundant set of circuits deliver matching or otherwise compatible results (e.g., the exact same result) due to a lack of soft errors and hard errors. In some embodiments, if the results are incompatible, the set of circuits may optionally be replaced with the redundant set of circuits. In some cases, this may optionally happen after the results for a subsequent set of circuits are confirmed to be compatible indicating that the error is due to the set of circuits rather than the redundant set of circuits. In some cases, this may optionally happen after the same set of circuits is checked again to ensure that the error is a hard error not a soft error. As another option, after the detection of the incompatibility, a hardware scan flow may be initiated to detect the set of circuits having the error. Replacing a set of circuits having a hard error with the redundant set of circuits may forsake the error checking capabilities described herein but may allow the matrix unit to remain useful despite experiencing a hard error for longer. This is optional not required.

In some embodiments, the comparison unit may optionally provide an indication 2122 (e.g., assert a signal, transmit a message, store a message in a register or other storage) when the first result 2114 generated by the selected or otherwise indicated first set of circuits is not compatible with the second result 2118 generated by the redundant set of circuits. In some embodiments, the indication may represent signaling or providing an exceptional condition, although this is not required. Examples of suitable exceptional conditions include, but are not limited to, exceptions, faults, traps, errors, machine check exceptions, or the like. In other embodiments, the indication may be other ways of communicating the incompatibility to software (e.g., quality control software, monitoring software, supervisory software, etc.). In some embodiments, the indication 2122 may provide one or more additional pieces of information. Examples of suitable pieces of information include, but are not limited to, an indication of the selected or otherwise indicates set of circuits (e.g., an indication of the first set of circuits 2110-1), an indication of a decoded instruction (e.g., a micro-operation, micro-op, microinstruction, etc.) that was used to control the selected or indicated set of circuits corresponding to the incompatibility, the first result 2114, the second result 2118, environmental conditions associated with the incompatibility (e.g., current local temperature and/or voltage of the selected or indicated set of circuits corresponding to the incompatibility), other information associated with the selected or indicated set of circuits, other information associated with the error, and the like, and any combination thereof.

In some embodiments, each of the plurality of sets of circuits may be selected or otherwise indicated one at a time or sequentially. For example, each of the plurality of sets of circuits may be checked one at a time, individually, or separately in a round robin fashion or scheme until all the plurality of sets of circuits have been checked. For example, after the first set of circuits has been checked, the first set of circuits may be logically disconnected from the comparison unit and a second set of circuits may be logically connected with the comparison unit and its associated result may be checked, and so on, until eventually the Nth second set of circuits may be logically connected with the comparison unit and its associated result may be checked. This may allow the entire matrix operations unit (e.g., all its MA circuits) to be checked over time by using the redundant set of circuits which includes less than all the circuits in the matrix operations unit. This approach is also a scalable solution if the size of the matrix operations unit increases (e.g., as more rows and/or columns are added). Hard errors tend to permanent or at least lasting so cycling through the plurality of sets of circuits may detect the hard errors within a sufficiently small amount of time, which in some cases may be before the result matrix has been fully generated and output. Another approach would be duplicate the entire matrix operations unit and use it to check all generated results at the same time but this approach tends to significantly increase the size, power consumption, and manufacturing cost. In contrast, the redundant set of circuits may provide sufficient detection of hard errors and sufficient prevention of SDEs but at a significantly lower size, power consumption, and manufacturing cost. Moreover, the checking of the matrix operations unit may be an ongoing process that is repeated throughout the operation of the matrix operations unit (e.g., continuously, or at least periodically). In some embodiments, the rate of checking may be configurable (e.g., by one or more bits in a control and/or configuration register) so that the rate of checking may be increased to provide greater error detection capability with higher power consumption or decreased to provide lower error detection capability with lower power consumption.

The use of the redundant set of circuits and the comparison unit in this way may provide for better detection of hard errors than soft errors. Soft errors often are not permanent or lasting. With N sets of circuits checked with a single redundant set of circuits, soft errors may only be detected around one out of N times. However, the matrix operations unit commonly tends to be less vulnerable to soft errors.

For one thing, the matrix operations unit may be implemented mainly with sequential elements (e.g., latches and flip-flops) and combinational logic without significant amounts of memory arrays thereby making it significantly less vulnerable to soft errors than memory arrays. The matrix operations unit may be mainly vulnerable to soft errors during the times the calculations are performed not so much after or between such calculations. Also, the sequential elements (e.g., latches and flip-flops) may be mainly vulnerable only during a portion of the clock cycle (e.g., during one portion of the clock cycle the latch is open and is relatively invulnerable to soft errors, whereas during another portion of the clock cycle the latch stores data and is relatively more vulnerable to soft errors). Soft error events may occur on combinational logic cell output but this tends to be limited by electrical masking, logic masking, and a relatively short time close to beginning of latch store data phase (the time when the latch catches the data to be stored) where there is greater vulnerability.

In some embodiments, the generation of the first and second results, and their comparison to detect hard errors and prevent SDEs, may both be done in real-time and during actual runtime operation of the matrix operations unit for its intended purpose of generating the result matrix as a useful result. Another approach may involve sequestering the matrix operations unit to run it mainly for the purposes of checking for hard errors without it being used to generate the result matrix as a useful result. However, a drawback to such an approach is that the matrix operations unit is effectively sequestered for checking/testing and is unable to produce useful work. In some embodiments, the generation of the first and second results, and their comparison to detect hard errors and prevent SDEs, may be performed at speed and otherwise under the actual conditions (e.g., clock speed, collector supply voltage drop, noise, local heating, etc.) the matrix operations unit experienced in generating the result matrix 2108 as a useful result. Another approach may involve sequestering the matrix operations unit to run it mainly for the purposes of checking for hard errors without it being used to generate the result matrix as a useful result. However, a drawback to such an approach is that it only provides stuck-at coverage not at-speed coverage and otherwise not under the actual conditions (e.g., clock speed, collector supply voltage drop, noise, local heating, etc.) encountered in generating the result matrix.

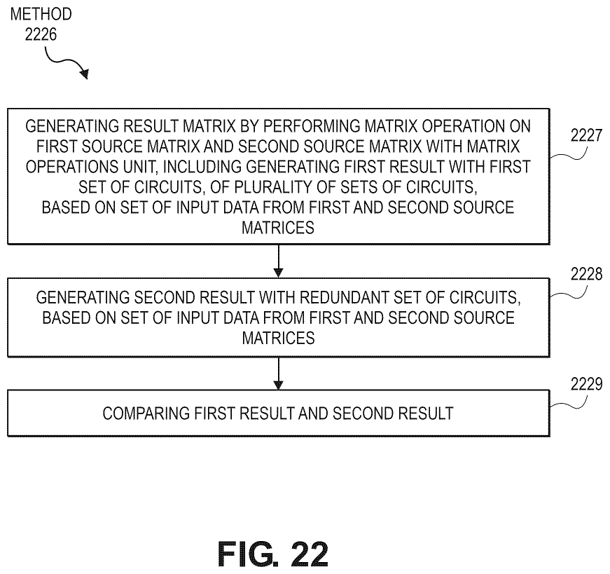

FIG. 22 is a block flow diagram of an embodiment of a method 2226. In various embodiments, the method may be performed by a processor, other integrated circuit, or other semiconductor device. In some embodiments, the method 2226 may be performed by and/or with the processor 2100 of FIG. 21. The components, features, and specific optional details described herein for the processor 2100 may also optionally apply to the method 2226. Alternatively, the method 2226 may be performed by and/or with a similar or different processor. Moreover, the processor 2100 may perform methods the same as, similar to, or different than the method 2226.

The method includes generating a result matrix by performing a matrix operation on a first source matrix and a second source matrix with a matrix operations unit, at block 2227. The previously described types of matrix operations (e.g., matrix multiplication with optional accumulation) and matrix operations units (e.g., matrix multiplication unit, TMUL unit, tensor core, TPU, etc.) are suitable. The generation of the result matrix includes generating a first result with a first set of (e.g., MA) circuits, of a plurality of sets of (e.g., MA) circuits of the matrix operations unit, based on a set of input data from the first and second source matrices. The first set of circuits may be selected or otherwise indicated as previously described (e.g., as part of a round robin process of selecting each of the plurality of sets of circuits one at a time). The previously described types of the sets of (e.g., MA) circuits are suitable. For example, in various embodiments, the plurality of sets of (e.g., MA) circuits may each be one or more columns (e.g., a single column) of (e.g., MA) circuits, one or more rows (e.g., a single row) of (e.g., MA) circuits, part of a single column of (e.g., MA) circuits, part of a single row of (e.g., MA) circuits, a non-systolic set of (e.g., MA) circuits, etc.

The method includes generating a second result with a redundant set of (e.g., MA) circuits, at block 2228. The previously described types of the redundant set of (e.g., MA) circuits are suitable. The second result is generated based on the set of input data from the first and second source matrices (e.g., the same set of input data that was used to generate the first result). In some embodiments, the method may include selecting the set of input data for input to the redundant set of circuits from among a plurality of sets of input data each corresponding to a different one of the plurality of sets of circuits.

The method includes comparing the first result and the second result, at block 2229. The previously described types of comparisons are suitable (e.g., a simple comparison for equality, if a difference between the first and second results is zero, comparisons based on logical operations, etc.). In some embodiments, the method may also include selecting the first result for input to the comparison unit from among a plurality of results each generated by a different one of the plurality of sets of circuits.

The method 2226 has been described in a relatively basic form, but operations may optionally be added to and/or removed from the method 2226. In addition, while the flow diagram shows a particular order of operations according to embodiments, that order is exemplary. Alternate embodiments may perform certain operations in different order, combine certain operations, overlap certain operations, etc.

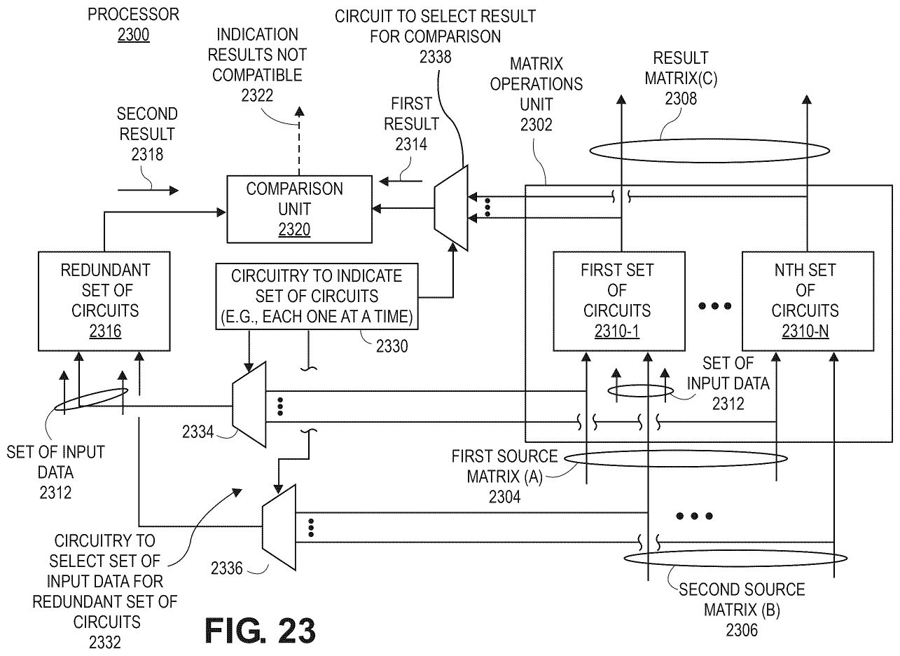

FIG. 23 is a block diagram of a first more detailed embodiment of a processor 2300 showing first circuitry 2330, second circuitry 2332, and third circuitry 2338. The previously described types of processors are suitable (e.g., a general-purpose processor, the various types of special purpose processors, etc.).

The processor includes a matrix operations unit 2302 to perform a matrix operation on a first source matrix (A) 2304 and a second source matrix (B) 2306 to generate a result matrix (C) 2308. The previously described types of matrix operations (e.g., matrix multiplication with optional accumulation) and matrix operations units (e.g., matrix multiplication unit, TMUL unit, tensor core, tensor processing unit, etc.) are suitable.

The matrix operations unit includes a plurality of sets of (e.g., MA) circuits, including a first set of circuits 2310-1 through an Nth set of circuits 2310-N. The previously described types of the sets of circuits are suitable. For example, in various embodiments, the plurality of sets of circuits may each be one or more columns (e.g., a single column) of (e.g., MA) circuits, one or more rows (e.g., a single row) of (e.g., MA) circuits, part of a single column of (e.g., MA) circuits, part of a single row of (e.g., MA) circuits, a non-systolic set of (e.g., MA) circuits, etc.

One of the plurality of sets of circuits may be selected or otherwise indicated as previously described (e.g., as part of selecting each of the plurality of sets of circuits one at a time or in a round robin fashion). The processor includes a first circuitry 2330 operative to select or otherwise indicate one of the plurality of sets of circuits as the indicated set of circuits. In the illustrated example embodiment, the first set of circuits 2310-1 has been selected or indicated. In some embodiments, the first circuitry may be operative to select or indicate each of the plurality of sets of circuits one at a time and/or according to a round robin approach. By way of example, in one illustrative embodiment, the first circuitry may include an M-bit modulo counter where the number N of the plurality of sets of circuits is 2\hat{ }M. For example, if the number N of the plurality of sets of circuits is sixteen, then the first circuitry may include a 4-bit modulo counter (e.g., 2\hat{ }4 equals 16). This M-bit modulo counter may be incremented (or decremented) each time a new set of calculations is to be performed and/or each time a new set of input data is provided or input to the matrix operations unit and/or for each new decoded instruction. The value of the M-bit modulo counter may be output as a selection control.

The processor also includes a redundant set of (e.g., MA) circuits 2316. The previously described types of the redundant set of circuits are suitable. For example, in various embodiments, the redundant set of circuits may be one or more columns (e.g., a single column) of (e.g., MA) circuits, one or more rows (e.g., a single row) of (e.g., MA) circuits, part of a single column of (e.g., MA) circuits, part of a single row of (e.g., MA) circuits, a non-systolic set of (e.g., MA) circuits, etc.

The processor includes a second circuitry 2332 coupled with the first circuitry 2330 to receive selection control (e.g., the value of the M-bit modulo counter) and coupled with the redundant set of circuits 2316. The second circuitry is operative to select, based on the selection control, a set of input data 2312 for input to the redundant set of circuits from among a plurality of sets of input data each corresponding to (e.g., provided or input to) a different one of the plurality of sets of circuits. As shown, the first set of circuits may receive the set of input data 2312 (e.g., which may include some input data from the first source matrix and some input data from the second source matrix). Likewise, each of the other sets of circuits of the matrix operations unit may receive a corresponding set of input data (e.g., which may include some input data from the first source matrix and some input data from the second source matrix). These N sets of input data may be provided or input to the second circuitry. The second circuitry may select one of these N sets of input data based on the selection control (e.g., the value of the M-bit modulo counter). For example, if the M-bit modulo counter is a value of 1 then the second circuitry may select the set of input data 2312 corresponding to the first set of circuits as an input to the redundant set of circuits. In some embodiments, the second circuitry may include one or more multiplexers. In the illustrated example, the second circuitry includes a first multiplexer 2334 to select between N sets of input data from the first source matrix, and a second multiplexer 2336 to select between N sets of input data from the second source matrix. Other selection circuitry is also suitable.

The processor also includes a third circuitry 2338 coupled with the first circuitry 2330 to receive selection control (e.g., the value of the M-bit modulo counter) and coupled with the comparison unit 2320. The third circuitry is operative to select, based on the selection control, a result for input to the comparison unit from among a plurality of results each corresponding to (e.g., generated by and/or output from) a different one of the plurality of sets of circuits. As shown, the first set of circuits may generate and output the first result. Likewise, each of the other sets of circuits of the matrix operations unit may generate and output a corresponding result. These N results may be provided or input to the third circuitry. The third circuitry may select one of these N results based on the selection control (e.g., the value of the M-bit modulo counter). For example, if the M-bit modulo counter is a value of 1 then the selection circuitry may select the first result 2314 corresponding to the first set of circuits for input to the comparison unit. In some embodiments, the third circuitry may include one or more multiplexers. In the illustrated example, the third circuitry includes a single multiplexer to select between N results. Other selection circuitry is also suitable.

The processor also includes a comparison unit 2320 coupled with the matrix operations unit and coupled with the redundant set of circuits. The comparison unit is to compare a first result 2314 generated by the selected or otherwise indicated set of circuits (e.g., in the illustrated example embodiment the first set of circuits) of the plurality of sets of circuits with a second result 2318 generated by the redundant set of circuits. Each of the first and second results are to be generated based on a same set of input data 2312 from the first and second source matrices. The previously described types of comparisons are suitable (e.g., a simple comparison for equality, if a difference between the first and second results is zero, comparisons based on logical operations, etc.). In some embodiments, an indication 2322 may optionally be provided to indicate when the first and second results are not compatible. The previously described types of indications (e.g., signals, messages, etc.) are suitable, and the indications may optionally include the various types of additional information described elsewhere herein (e.g., an indication of the set of circuits, an indication of a decoded instruction, etc.).

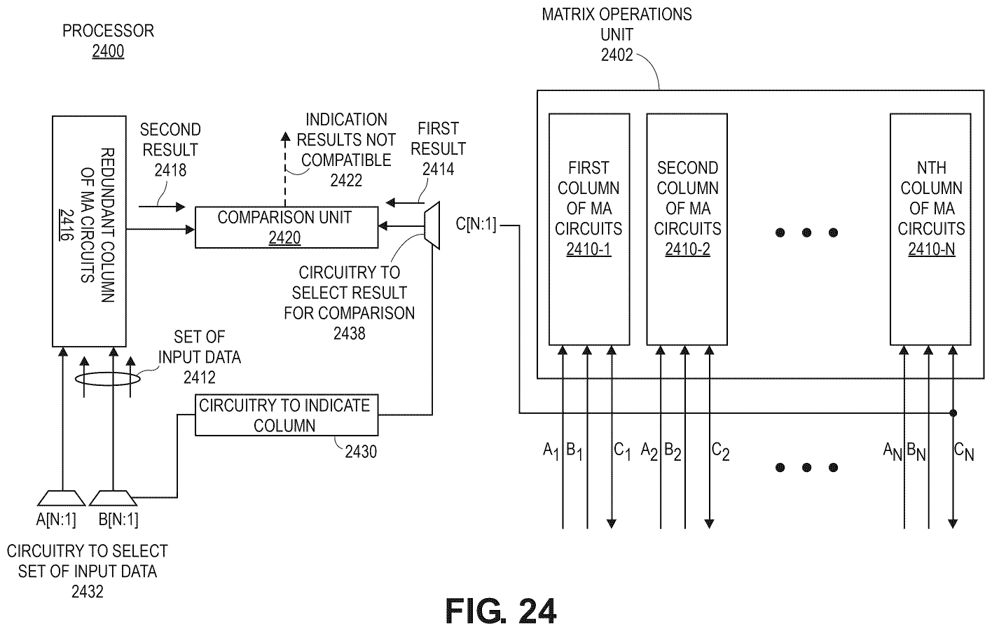

FIG. 24 is a block diagram of a second more detailed embodiment of a processor 2400 having a matrix operations unit 2402 with columns of MA circuits 2410 and a redundant column of MA circuits 2416. The previously described types of processors are suitable (e.g., a general-purpose processor, the various types of special purpose processors, etc.).

The processor includes a matrix operations unit 2402 to perform a matrix operation on a first source matrix (A) and a second source matrix (B) to generate a result matrix (C). The previously described types of matrix operations (e.g., matrix multiplication with optional accumulation) and matrix operations units (e.g., matrix multiplication unit, TMUL unit, tensor core, tensor processing unit, etc.) are suitable.

The matrix operations unit includes a plurality of columns of MA circuits, including a first column of MA circuits 2410-1, a second column of MA circuits 2410-2, and so on, through an Nth column of MA circuits 2410-N. In some embodiments, the plurality of columns of MA circuits are a plurality of non-systolic columns of MA circuits.

One of the plurality of columns of MA circuits may be selected or otherwise indicated as previously described (e.g., as part of selecting each of the plurality of columns of MA circuits one at a time or in a round robin fashion). The processor also includes a first circuitry 2430 operative to select or otherwise indicate one of the plurality of columns of MA circuits as the indicated column of MA circuits. In the illustrated example embodiment, the first column of MA circuits 2410-1 has been selected or indicated. In some embodiments, the first circuitry may be operative to select or indicate each of the plurality of columns of MA circuits one at a time and/or according to a round robin approach. The previously described types of circuitry (e.g., the M-bit modulo counter) are suitable. The first circuitry may output a selection control.

The processor also includes a redundant column of MA circuits 2416. In some embodiments, the redundant column of MA circuits may be a non-systolic redundant column of MA circuits.

The processor includes a second circuitry 2432 coupled with the first circuitry 2430 to the receive selection control (e.g., the value of the M-bit modulo counter) and coupled with the redundant column of MA circuits 2416. The second circuitry may be operative to select, based on the selection control, a set of input data for input to the redundant column of MA circuits from among a plurality of sets of input data each corresponding to (e.g., provided or input to) a different one of the plurality of columns of MA circuits. Each of the columns of MA circuits may receive a corresponding set of input data from the first source matrix (A), the second source matrix (B) and optionally in the case of accumulation also from the result matrix (C). As shown, the first column of MA circuits may receive as its input data A1, B1, and optionally C1, the second column of MA circuits may receive as its input data A2, B2, and optionally C2, and the Nth column of MA circuits may receive as its input data AN, BN, and optionally CN. These N sets of input data may be provided or input to the second circuitry. In the illustration, this is shown as A[N:1] and B[N:1]. The second circuitry may select one of these N sets of input data based on the selection control (e.g., the value of the M-bit modulo counter). The previously described types of circuitry (e.g., one or more multiplexers) are suitable.

The processor also includes a third circuitry 2438 coupled with the first circuitry 2430 to receive the selection control (e.g., the value of the M-bit modulo counter) and coupled with the comparison unit 2420. The third circuitry is operative to select, based on the selection control, a result for input to the comparison unit from among a plurality of results each corresponding to (e.g., generated by and/or output from) a different one of the plurality of columns of MA circuits. As shown, the first column of MA circuits may generate and output a result C1, the second column of MA circuits may generate and output a result C2, and the Nth column of MA circuits may generate and output a result CN. These N results may be provided or input to the third circuitry. The third circuitry may select one of these N results based on the selection control (e.g., the value of the M-bit modulo counter). The previously described types of circuitry (e.g., one or more multiplexers) are suitable.

The processor also includes a comparison unit 2430 coupled with the matrix operations unit and coupled with the redundant column of MA circuits. The comparison unit may be operative to compare a first result 2414 generated by the selected or otherwise indicated column of MA circuits (e.g., in this example the first column of MA circuits) with a second result 2418 generated by the redundant column of MA circuits. Each of the first and second results are to be generated based on a same set of input data from the first and second source matrices (e.g., in this example A1, B1, and optionally C1 in the optional case of accumulation). The previously described types of comparisons are suitable (e.g., a simple comparison for equality, if a difference between the first and second results is zero, comparisons based on logical operations, etc.). In some embodiments, an indication 2422 may optionally be provided to indicate when the first and second results are not compatible. The previously described types of indications (e.g., signals, messages, etc.) are suitable, and the indications may optionally include the various types of additional information described elsewhere herein (e.g., an indication of the selected column of MA circuits, an indication of a decoded instruction used to control the comparison, etc.).

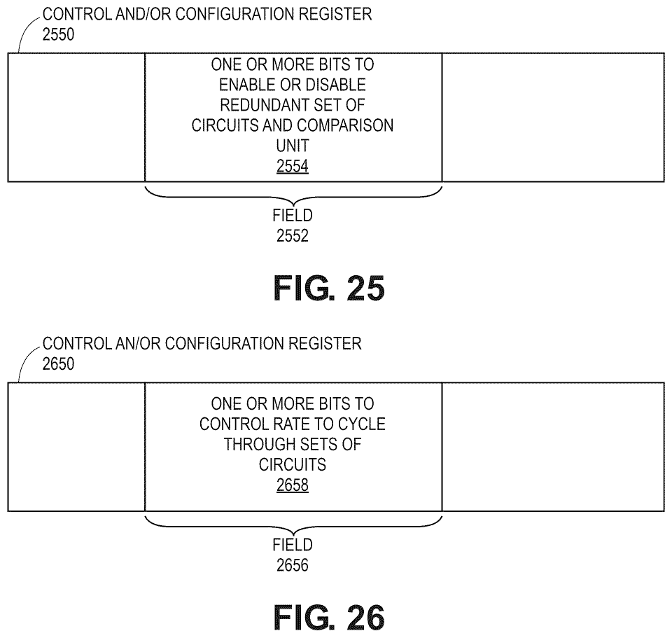

FIG. 25 is a block diagram of an embodiment of a control and/or configuration register 2550 (e.g., a model specific register, a feature register, a system control register, etc.) having at least one field 2552 to store one or more bits 2554 to enable and/or disable use of a redundant set of circuits and a comparison unit (e.g., those shown in any of FIG. 21, 23, or 24). The one or more bits may have at least a first value to enable use of the redundant set of circuits and the comparison unit and a second value to disable use of the redundant set of circuits and the comparison unit. As one example, a single bit may have a first binary value (e.g., be set to binary one) to enable use of the redundant set of circuits or a second binary value (e.g., be cleared to binary zero) to disable use of the redundant set of circuits and the comparison unit. The redundant set of circuits and the comparison unit may optionally be clock gated or otherwise put in a reduced power consumption state when their use is disabled.

FIG. 26 is a block diagram of an embodiment of a control and/or configuration register 2650 (e.g., a model specific register, a feature register, a system control register, etc.) having at least one field 2656 to store one or more bits 2658 to configure and/or control and/or change a rate associated with use of a redundant set of circuits and a comparison unit (e.g., those shown in any of FIG. 21, 23, or 24). As one example, the one or more bits may configure, control, or change a rate at which to repeat selecting or otherwise indicating each of the plurality of sets of circuits one at a time. Higher rates of checking for errors generally provide better detection of errors whereas lower rates of checking may be used to provide reduced power consumption. By way of example, after cycling through each of the plurality of sets of circuits one at a time, based on the one or more bits, the processor may either immediately start cycling through each of the plurality of sets of circuits one at a time again, or the processor may wait for a period of time that depends on a rate indicated by the one or more bits. As one illustrative example, the one or more bits may optionally include two bits that have either a first value (e.g., 00) to indicate continuous or constant cycling through the plurality of sets of circuits without stopping, a second value (e.g., 01) to indicate a first period of time or delay (e.g., which may be a number on the order of tens of clock cycles) that the processor is to wait between sequential round robins in which the processor selects each of the plurality of sets of circuits one at a time, a third value (e.g., 10) to indicate a second period of time or delay (e.g., which may be a number on the order of hundreds of clock cycles) that the processor is to wait between sequential round robins in which the processor selects each of the plurality of sets of circuits one at a time, or a fourth value (e.g., 11) to indicate a third period of time or delay (e.g., which may be a number on the order of thousands of clock cycles) that the processor is to wait between sequential round robins in which the processor selects each of the plurality of sets of circuits one at a time. The redundant set of circuits and the comparison unit may optionally be clock gated or otherwise put in a reduced power consumption state during such periods of delay or this may be based on the extent of the delay (e.g., only used for periods of delay greater than a threshold). In some embodiments, the processor may optionally be operative to automatically change the rate of checking of results as described herein. For example, this may optionally be done based on one or more current conditions (e.g., the rate may be increased at high temperatures and/or high voltages and/or when hard errors are more likely and the rate may be decreased at low temperatures and/or low voltages and/or when hard errors are less likely). The rate may also be changed based on other factors affecting hard errors (e.g., age of the device, etc.). Reduction of checking error rate will reduce power consumption/increase the performance in power limited systems. On the other hand, it will tend to reduce the probability of soft error detection (this probability is low anyway) and increase the average time between hard error manifest and the error detection. Thus, by reduction of checking error rate from the maximal level, some power can be saved but with a tradeoff in error detection. Alternatively, rather than automatic adjustment, in some embodiments, the checking rate may be changed manually by software (e.g., writing to a control and/or configuration register). The running workload may have the marker which reflects the required quality level. For example, it could be defined the default checking rate which can be reduced or increased depending on workload marker.

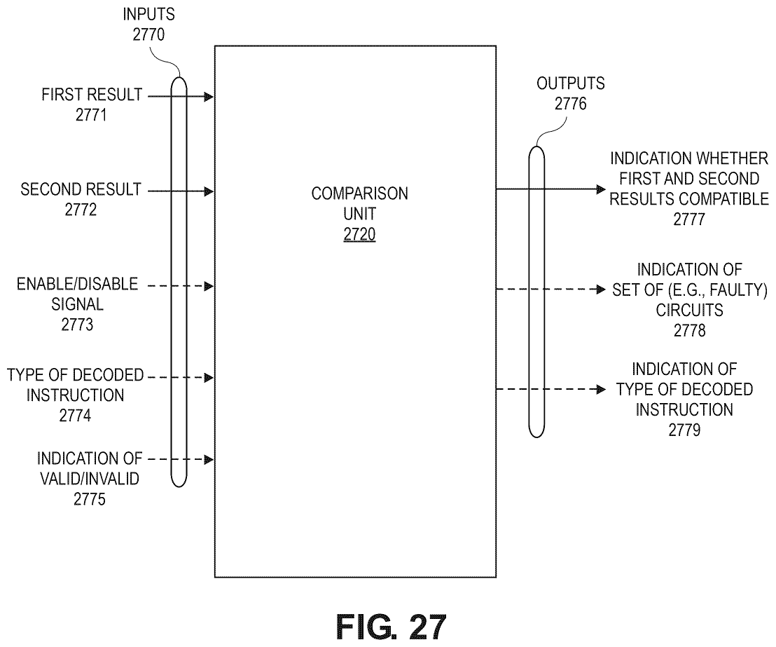

FIG. 27 is a block diagram of an embodiment of a comparison unit 2720 showing example inputs 2770 and outputs 2776. The comparison unit may optionally be used as the comparison unit 2120 of FIG. 21, the comparison unit 2320 of FIG. 23, and the comparison unit 2420 of FIG. 24. Alternatively, the processors of FIGS. 21, 23, and 24 may optionally use similar or different comparison units.

The comparison unit may be coupled to receive several inputs 2770. The inputs may include a first result 2771 from an indicated or selected set of circuits and a second result 2772 from a redundant set of circuits. In some embodiments, the inputs may optionally include an enable/disable signal 2773 to either enable or disable use of the comparison unit and the redundant set of circuits. In some embodiments, the inputs may optionally include the type 2774 of the decoded instruction used to control the indicated set of circuits to generate the first result. Some matrix operations units can perform different types of matrix operations so knowing the type of the decoded instruction may be useful to better understand the errors, diagnose the causes of the errors, etc. In some embodiments, the inputs may optionally include an indication 2775 of whether the decoded instruction (e.g., used to control the indicated set of circuits to generate the first result) is valid or invalid. The first and second results may be compared when the decoded instruction is valid but the comparison may optionally be omitted if the decoded instruction is indicated to be invalid. In one specific example embodiment, the comparison unit may compare the first result and the second result, and generate an indication based on the comparison, when the enable/disable signal enables the comparison unit and the decoded instruction is indicated to be valid and

The comparison unit may output or provide several outputs 2776. The outputs may include an indication 2777 whether the first and second results match or are otherwise compatible. By way of example, this indication may be made to have a first value (e.g., de-asserted to binary zero) upon reset and made to have a second value (e.g., set to binary one) when the first and second results are not compatible. In some embodiments, the outputs may optionally include an indication 2778 of the indicated or selected set of circuits (e.g., the one that generated the first result). In some embodiments, the outputs may optionally include an indication 2779 of the type of the decoded instruction used to control the indicated set of circuits to generate the first result.

While embodiments have been described for a matrix operation unit other embodiments are not limited to implementation in a matrix operations unit. Other embodiments may optionally be used in other types of data generation circuitry or logic including a number of structures, circuits, or logic operating in parallel or concurrently. Examples include superscalar or otherwise parallel identical execution units, superscalar or otherwise parallel identical sets of accelerator circuitry, superscalar or otherwise parallel identical SIMD execution units, and the like. In such embodiments, an additional redundant structures, circuits, or logic may similarly be used to generate a result that may be checked against the result generated by one of the main structures, circuits, or logic. The number of structures, circuits, or logic may be cycled through in round robin mode as disclosed elsewhere herein.

### Example Computer Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

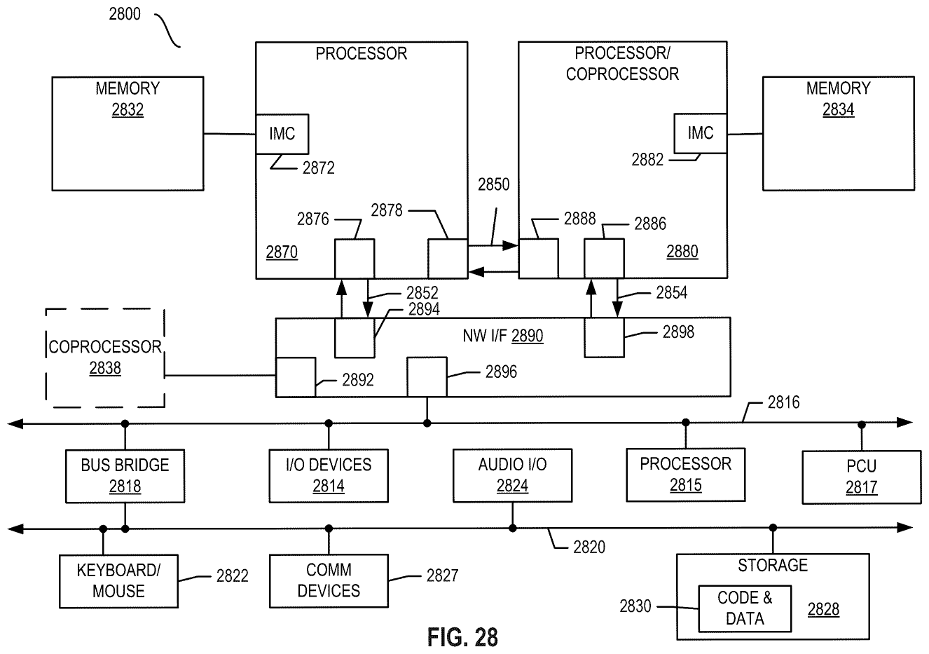

FIG. 28 illustrates an example computing system. Multiprocessor system 2800 is an interfaced system and includes a plurality of processors or cores including a first processor 2870 and a second processor 2880 coupled via an interface 2850 such as a point-to-point (P-P) interconnect, a fabric, and/or bus. In some examples, the first processor 2870 and the second processor 2880 are homogeneous. In some examples, the first processor 2870 and the second processor 2880 are heterogenous. Though the example system 2800 is shown to have two processors, the system may have three or more processors, or may be a single processor system. In some examples, the computing system is a system on a chip (SoC).

Processors 2870 and 2880 are shown including integrated memory controller (IMC) circuitry 2872 and 2882, respectively. Processor 2870 also includes interface circuits 2876 and 2878; similarly, second processor 2880 includes interface circuits 2886 and 2888. Processors 2870, 2880 may exchange information via the interface 2850 using interface circuits 2878, 2888. IMCs 2872 and 2882 couple the processors 2870, 2880 to respective memories, namely a memory 2832 and a memory 2834, which may be portions of main memory locally attached to the respective processors.

Processors 2870, 2880 may each exchange information with a network interface (NW I/F) 2890 via individual interfaces 2852, 2854 using interface circuits 2876, 2894, 2886, 2898. The network interface 2890 (e.g., one or more of an interconnect, bus, and/or fabric, and in some examples is a chipset) may optionally exchange information with a coprocessor 2838 via an interface circuit 2892. In some examples, the coprocessor 2838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 2870, 2880 or outside of both processors, yet connected with the processors via an interface such as P-P interconnect, such that either or both processors' local cache information may be stored in the shared cache if a processor is placed into a low power mode.

Network interface 2890 may be coupled to a first interface 2816 via interface circuit 2896. In some examples, the first interface 2816 may be an interface such as a Peripheral Component Interconnect (PCI) interconnect, a PCI Express interconnect or another I/O interconnect. In some examples, the first interface 2816 is coupled to a power control unit (PCU) 2817, which may include circuitry, software, and/or firmware to perform power management operations regarding the processors 2870, 2880 and/or co-processor 2838. PCU 2817 provides control information to a voltage regulator (not shown) to cause the voltage regulator to generate the appropriate regulated voltage. PCU 2817 also provides control information to control the operating voltage generated. In various examples, PCU 2817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 2817 is illustrated as being present as logic separate from the processor 2870 and/or processor 2880. In other cases, PCU 2817 may execute on a given one or more of cores (not shown) of processor 2870 or 2880. In some cases, PCU 2817 may be implemented as a microcontroller (dedicated or general-purpose) or other control logic configured to execute its own dedicated power management code, sometimes referred to as P-code. In yet other examples, power management operations to be performed by PCU 2817 may be implemented externally to a processor, such as by way of a separate power management integrated circuit (PMIC) or another component external to the processor. In yet other examples, power management operations to be performed by PCU 2817 may be implemented within BIOS or other system software.

Various I/O devices 2814 may be coupled to first interface 2816, along with a bus bridge 2818 which couples first interface 2816 to a second interface 2820. In some examples, one or more additional processor(s) 2815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 2816. In some examples, the second interface 2820 may be a low pin count (LPC) interface. Various devices may be coupled to second interface 2820 including, for example, a keyboard and/or mouse 2822, communication devices 2827 and storage circuitry 2828. Storage circuitry 2828 may be one or more non-transitory machine-readable storage media as described below, such as a disk drive or other mass storage device which may include instructions/code and data 2830 and may implement the storage 'ISAB03 in some examples. Further, an audio I/O 2824 may be coupled to second interface 2820. Note that other architectures than the point-to-point architecture described above are possible. For example, instead of the point-to-point architecture, a system such as multiprocessor system 2800 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

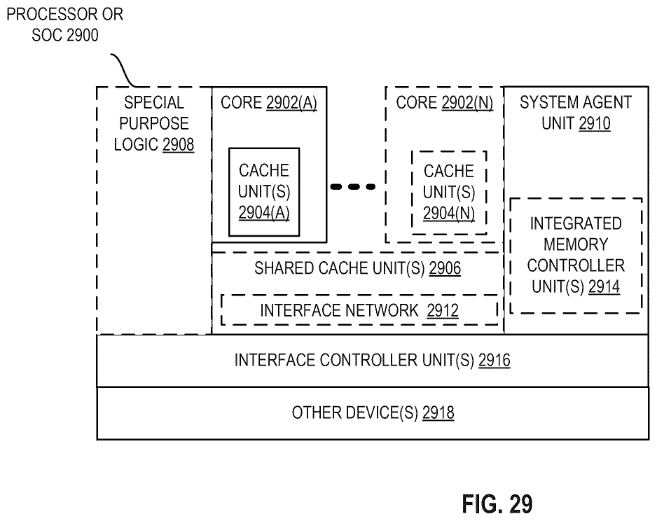

FIG. 29 illustrates a block diagram of an example processor and/or SoC 2900 that may have one or more cores and an integrated memory controller. The solid lined boxes illustrate a processor 2900 with a single core 2902(A), system agent unit circuitry 2910, and a set of one or more interface controller unit(s) circuitry 2916, while the optional addition of the dashed lined boxes illustrates an alternative processor 2900 with multiple cores 2902(A)-(N), a set of one or more integrated memory controller unit(s) circuitry 2914 in the system agent unit circuitry 2910, and special purpose logic 2908, as well as a set of one or more interface controller units circuitry 2916. Note that the processor 2900 may be one of the processors 2870 or 2880, or co-processor 2838 or 2815 of FIG. 28.

Thus, different implementations of the processor 2900 may include: 1) a CPU with the special purpose logic 2908 being integrated graphics and/or scientific (throughput) logic (which may include one or more cores, not shown), and the cores 2902(A)-(N) being one or more general purpose cores (e.g., general purpose in-order cores, general purpose out-of-order cores, or a combination of the two); 2) a coprocessor with the cores 2902(A)-(N) being a large number of special purpose cores intended primarily for graphics and/or scientific (throughput); and 3) a coprocessor with the cores 2902(A)-(N) being a large number of general purpose in-order cores. Thus, the processor 2900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 2900 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 2904(A)-(N) within the cores 2902(A)-(N), a set of one or more shared cache unit(s) circuitry 2906, and external memory (not shown) coupled to the set of integrated memory controller unit(s) circuitry 2914. The set of one or more shared cache unit(s) circuitry 2906 may include one or more mid-level caches, such as level 2 (L2), level 3 (L3), level 4 (L4), or other levels of cache, such as a last level cache (LLC), and/or combinations thereof. While in some examples interface network circuitry 2912 (e.g., a ring interconnect) interfaces the special purpose logic 2908 (e.g., integrated graphics logic), the set of shared cache unit(s) circuitry 2906, and the system agent unit circuitry 2910, alternative examples use any number of well-known techniques for interfacing such units. In some examples, coherency is maintained between one or more of the shared cache unit(s) circuitry 2906 and cores 2902(A)-(N). In some examples, interface controller units circuitry 2916 couple the cores 2902 to one or more other devices 2918 such as one or more I/O devices, storage, one or more communication devices (e.g., wireless networking, wired networking, etc.), etc.

In some examples, one or more of the cores 2902(A)-(N) are capable of multi-threading. The system agent unit circuitry 2910 includes those components coordinating and operating cores 2902(A)-(N). The system agent unit circuitry 2910 may include, for example, power control unit (PCU) circuitry and/or display unit circuitry (not shown). The PCU may be or may include logic and components needed for regulating the power state of the cores 2902(A)-(N) and/or the special purpose logic 2908 (e.g., integrated graphics logic). The display unit circuitry is for driving one or more externally connected displays.

The cores 2902(A)-(N) may be homogenous in terms of instruction set architecture (ISA). Alternatively, the cores 2902(A)-(N) may be heterogeneous in terms of ISA; that is, a subset of the cores 2902(A)-(N) may be capable of executing an ISA, while other cores may be capable of executing only a subset of that ISA or another ISA.

Example Core Architectures-In-order and out-of-order core block diagram.

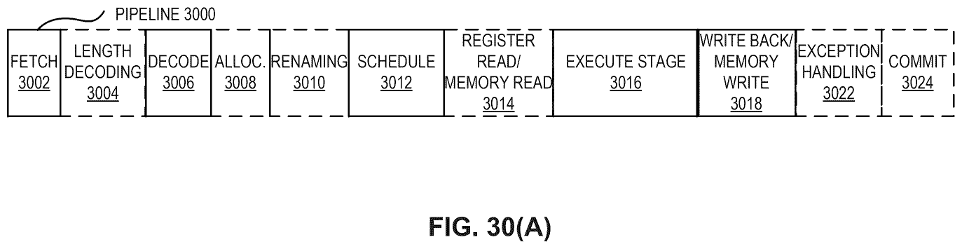

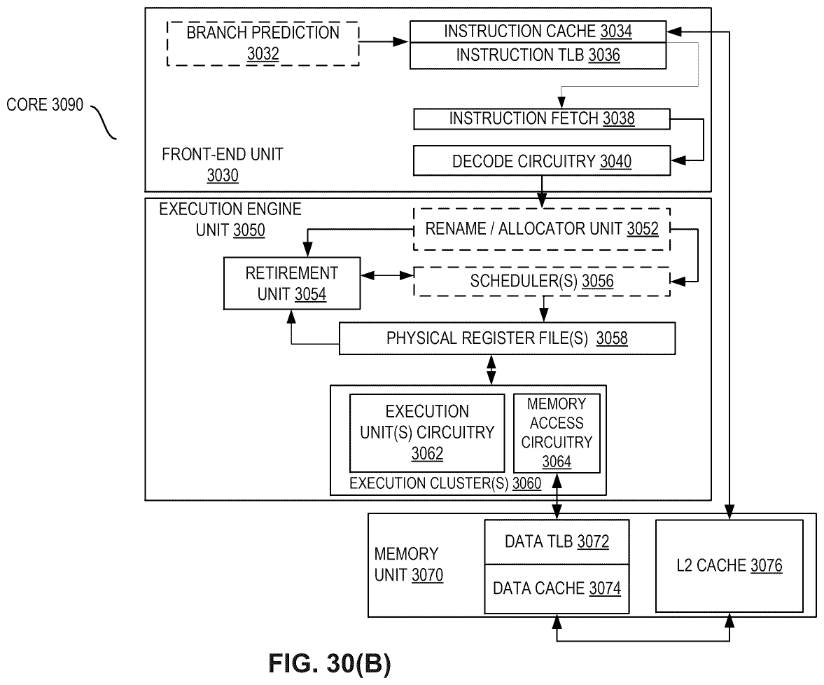

FIG. 30(A) is a block diagram illustrating both an example in-order pipeline and an example register renaming, out-of-order issue/execution pipeline according to examples. FIG. 30(B) is a block diagram illustrating both an example in-order architecture core and an example register renaming, out-of-order issue/execution architecture core to be included in a processor according to examples. The solid lined boxes in FIGS. 30(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 30(A), a processor pipeline 3000 includes a fetch stage 3002, an optional length decoding stage 3004, a decode stage 3006, an optional allocation (Alloc) stage 3008, an optional renaming stage 3010, a schedule (also known as a dispatch or issue) stage 3012, an optional register read/memory read stage 3014, an execute stage 3016, a write back/memory write stage 3018, an optional exception handling stage 3022, and an optional commit stage 3024. One or more operations can be performed in each of these processor pipeline stages. For example, during the fetch stage 3002, one or more instructions are fetched from instruction memory, and during the decode stage 3006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 3006 and the register read/memory read stage 3014 may be combined into one pipeline stage. In one example, during the execute stage 3016, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 30(B) may implement the pipeline 3000 as follows: 1) the instruction fetch circuitry 3038 performs the fetch and length decoding stages 3002 and 3004; 2) the decode circuitry 3040 performs the decode stage 3006; 3) the rename/allocator unit circuitry 3052 performs the allocation stage 3008 and renaming stage 3010; 4) the scheduler(s) circuitry 3056 performs the schedule stage 3012; 5) the physical register file(s) circuitry 3058 and the memory unit circuitry 3070 perform the register read/memory read stage 3014; the execution cluster(s) 3060 perform the execute stage 3016; 6) the memory unit circuitry 3070 and the physical register file(s) circuitry 3058 perform the write back/memory write stage 3018; 7) various circuitry may be involved in the exception handling stage 3022; and 8) the retirement unit circuitry 3054 and the physical register file(s) circuitry 3058 perform the commit stage 3024.

FIG. 30(B) shows a processor core 3090 including front-end unit circuitry 3030 coupled to execution engine unit circuitry 3050, and both are coupled to memory unit circuitry 3070. The core 3090 may be a reduced instruction set architecture computing (RISC) core, a complex instruction set architecture computing (CISC) core, a very long instruction word (VLIW) core, or a hybrid or alternative core type. As yet another option, the core 3090 may be a special-purpose core, such as, for example, a network or communication core, compression engine, coprocessor core, general purpose computing graphics processing unit (GPGPU) core, graphics core, or the like.

The front-end unit circuitry 3030 may include branch prediction circuitry 3032 coupled to instruction cache circuitry 3034, which is coupled to an instruction translation lookaside buffer (TLB) 3036, which is coupled to instruction fetch circuitry 3038, which is coupled to decode circuitry 3040. In one example, the instruction cache circuitry 3034 is included in the memory unit circuitry 3070 rather than the front-end circuitry 3030. The decode circuitry 3040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 3040 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 3040 may be implemented using various mechanisms. Examples of suitable mechanisms include, but are not limited to, look-up tables, hardware implementations, programmable logic arrays (PLAs), microcode read only memories (ROMs), etc. In one example, the core 3090 includes a microcode ROM (not shown) or other medium that stores microcode for certain macroinstructions (e.g., in decode circuitry 3040 or otherwise within the front-end circuitry 3030). In one example, the decode circuitry 3040 includes a micro-operation (micro-op) or operation cache (not shown) to hold/cache decoded operations, micro-tags, or micro-operations generated during the decode or other stages of the processor pipeline 3000. The decode circuitry 3040 may be coupled to rename/allocator unit circuitry 3052 in the execution engine circuitry 3050.

The execution engine circuitry 3050 includes the rename/allocator unit circuitry 3052 coupled to retirement unit circuitry 3054 and a set of one or more scheduler(s) circuitry 3056. The scheduler(s) circuitry 3056 represents any number of different schedulers, including reservations stations, central instruction window, etc. In some examples, the scheduler(s) circuitry 3056 can include arithmetic logic unit (ALU) scheduler/scheduling circuitry, ALU queues, address generation unit (AGU) scheduler/scheduling circuitry, AGU queues, etc. The scheduler(s) circuitry 3056 is coupled to the physical register file(s) circuitry 3058. Each of the physical register file(s) circuitry 3058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 3058 includes vector registers unit circuitry, writemask registers unit circuitry, and scalar register unit circuitry. These register units may provide architectural vector registers, vector mask registers, general-purpose registers, etc. The physical register file(s) circuitry 3058 is coupled to the retirement unit circuitry 3054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 3054 and the physical register file(s) circuitry 3058 are coupled to the execution cluster(s) 3060. The execution cluster(s) 3060 includes a set of one or more execution unit(s) circuitry 3062 and a set of one or more memory access circuitry 3064. The execution unit(s) circuitry 3062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 3056, physical register file(s) circuitry 3058, and execution cluster(s) 3060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 3064). It should also be understood that where separate pipelines are used, one or more of these pipelines may be out-of-order issue/execution and the rest in-order.

In some examples, the execution engine unit circuitry 3050 may perform load store unit (LSU) address/data pipelining to an Advanced Microcontroller Bus (AMB) interface (not shown), and address phase and writeback, data phase load, store, and branches.

The set of memory access circuitry 3064 is coupled to the memory unit circuitry 3070, which includes data TLB circuitry 3072 coupled to data cache circuitry 3074 coupled to level 2 (L2) cache circuitry 3076. In one example, the memory access circuitry 3064 may include load unit circuitry, store address unit circuitry, and store data unit circuitry, each of which is coupled to the data TLB circuitry 3072 in the memory unit circuitry 3070. The instruction cache circuitry 3034 is further coupled to the level 2 (L2) cache circuitry 3076 in the memory unit circuitry 3070. In one example, the instruction cache 3034 and the data cache 3074 are combined into a single instruction and data cache (not shown) in L2 cache circuitry 3076, level 3 (L3) cache circuitry (not shown), and/or main memory. The L2 cache circuitry 3076 is coupled to one or more other levels of cache and eventually to a main memory.

The core 3090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 3090 includes logic to support a packed data instruction set architecture extension (e.g., AVX1, AVX2), thereby allowing the operations used by many multimedia applications to be performed using packed data.

### Example Execution Unit(s) Circuitry

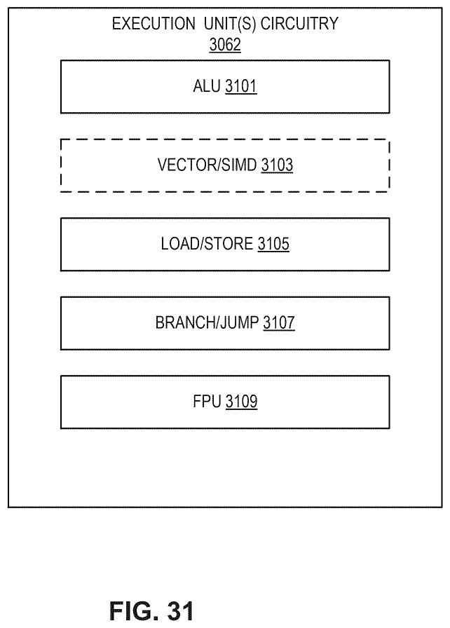

FIG. 31 illustrates examples of execution unit(s) circuitry, such as execution unit(s) circuitry 3062 of FIG. 30(B). As illustrated, execution unit(s) circuitry 3062 may include one or more ALU circuits 3101, optional vector/single instruction multiple data (SIMD) circuits 3103, load/store circuits 3105, branch/jump circuits 3107, and/or Floating-point unit (FPU) circuits 3109. ALU circuits 3101 perform integer arithmetic and/or Boolean operations. Vector/SIMD circuits 3103 perform vector/SIMD operations on packed data (such as SIMD/vector registers). Load/store circuits 3105 execute load and store instructions to load data from memory into registers or store from registers to memory. Load/store circuits 3105 may also generate addresses. Branch/jump circuits 3107 cause a branch or jump to a memory address depending on the instruction. FPU circuits 3109 perform floating-point arithmetic. The width of the execution unit(s) circuitry 3062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

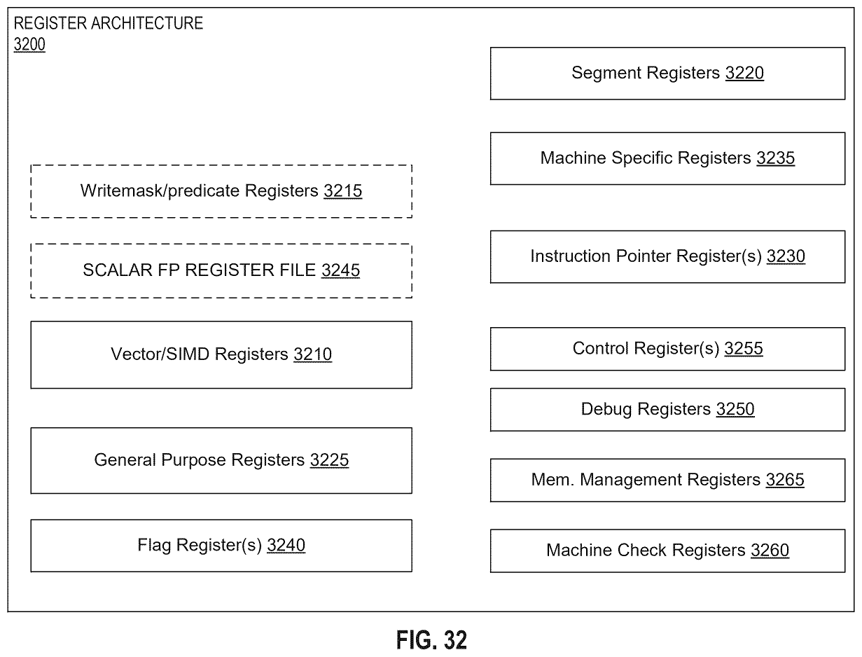

FIG. 32 is a block diagram of a register architecture 3200 according to some examples. As illustrated, the register architecture 3200 includes vector/SIMD registers 3210 that vary from 128-bit to 1,024 bits width. In some examples, the vector/SIMD registers 3210 are physically 512-bits and, depending upon the mapping, only some of the lower bits are used. For example, in some examples, the vector/SIMD registers 3210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 3200 includes writemask/predicate registers 3215. For example, in some examples, there are 8 writemask/predicate registers (sometimes called k0 through k7) that are each 16-bit, 32-bit, 64-bit, or 128-bit in size. Writemask/predicate registers 3215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 3215 corresponds to a data element position of the destination. In other examples, the writemask/predicate registers 3215 are scalable and consists of a set number of enable bits for a given vector element (e.g., 8 enable bits per 64-bit vector element).

The register architecture 3200 includes a plurality of general-purpose registers 3225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 3200 includes scalar floating-point (FP) register file 3245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 3240 (e.g., EFLAGS, RFLAGS, etc.) store status and control information for arithmetic, compare, and system operations. For example, the one or more flag registers 3240 may store condition code information such as carry, parity, auxiliary carry, zero, sign, and overflow. In some examples, the one or more flag registers 3240 are called program status and control registers.

Segment registers 3220 contain segment points for use in accessing memory. In some examples, these registers are referenced by the names CS, DS, SS, ES, FS, and GS.

Machine specific registers (MSRs) 3235 control and report on processor performance. Most MSRs 3235 handle system-related functions and are not accessible to an application program. Machine check registers 3260 consist of control, status, and error reporting MSRs that are used to detect and report on hardware errors.

One or more instruction pointer register(s) 3230 store an instruction pointer value. Control register(s) 3255 (e.g., CR0-CR4) determine the operating mode of a processor (e.g., processor 2870, 2880, 2838, 2815, and/or 2900) and the characteristics of a currently executing task. Debug registers 3250 control and allow for the monitoring of a processor or core's debugging operations.

Memory (mem) management registers 3265 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 3200 may, for example, be used in register file/memory ‘ISAB08, or physical register file(s) circuitry 30 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

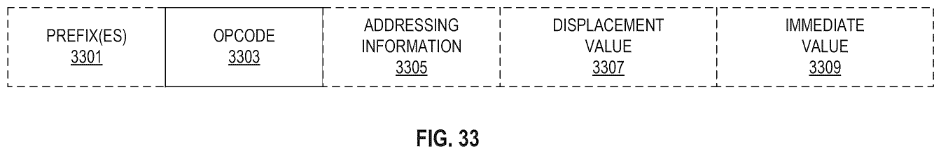

FIG. 33 illustrates examples of an instruction format. As illustrated, an instruction may include multiple components including, but not limited to, one or more fields for: one or more prefixes 3301, an opcode 3303, addressing information 3305 (e.g., register identifiers, memory addressing information, etc.), a displacement value 3307, and/or an immediate value 3309. Note that some instructions utilize some or all the fields of the format whereas others may only use the field for the opcode 3303. In some examples, the order illustrated is the order in which these fields are to be encoded, however, it should be appreciated that in other examples these fields may be encoded in a different order, combined, etc.

The prefix(es) field(s) 3301, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 3303 is used to at least partially define the operation to be performed upon a decoding of the instruction. In some examples, a primary opcode encoded in the opcode field 3303 is one, two, or three bytes in length. In other examples, a primary opcode can be a different length. An additional 3-bit opcode field is sometimes encoded in another field.

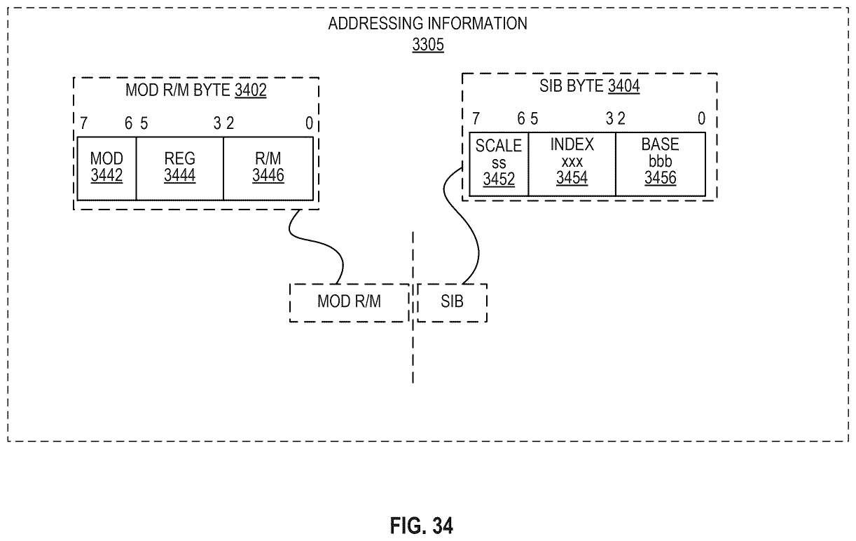

The addressing information field 3305 is used to address one or more operands of the instruction, such as a location in memory or one or more registers. FIG. 34 illustrates examples of the addressing information field 3305. In this illustration, an optional MOD R/M byte 3402 and an optional Scale, Index, Base (SIB) byte 3404 are shown. The MOD R/M byte 3402 and the SIB byte 3404 are used to encode up to two operands of an instruction, each of which is a direct register or effective memory address. Note that both fields are optional in that not all instructions include one or more of these fields. The MOD R/M byte 3402 includes a MOD field 3442, a register (reg) field 3444, and R/M field 3446.

The content of the MOD field 3442 distinguishes between memory access and non-memory access modes. In some examples, when the MOD field 3442 has a binary value of 11 (11 b), a register-direct addressing mode is utilized, and otherwise a register-indirect addressing mode is used.

The register field 3444 may encode either the destination register operand or a source register operand or may encode an opcode extension and not be used to encode any instruction operand. The content of register field 3444, directly or through address generation, specifies the locations of a source or destination operand (either in a register or in memory). In some examples, the register field 3444 is supplemented with an additional bit from a prefix (e.g., prefix 3301) to allow for greater addressing.

The R/M field 3446 may be used to encode an instruction operand that references a memory address or may be used to encode either the destination register operand or a source register operand. Note the R/M field 3446 may be combined with the MOD field 3442 to dictate an addressing mode in some examples.

The SIB byte 3404 includes a scale field 3452, an index field 3454, and a base field 3456 to be used in the generation of an address. The scale field 3452 indicates a scaling factor. The index field 3454 specifies an index register to use. In some examples, the index field 3454 is supplemented with an additional bit from a prefix (e.g., prefix 3301) to allow for greater addressing. The base field 3456 specifies a base register to use. In some examples, the base field 3456 is supplemented with an additional bit from a prefix (e.g., prefix 3301) to allow for greater addressing. In practice, the content of the scale field 3452 allows for the scaling of the content of the index field 3454 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 3307 provides this value. Additionally, in some examples, a displacement factor usage is encoded in the MOD field of the addressing information field 3305 that indicates a compressed displacement scheme for which a displacement value is calculated and stored in the displacement field 3307.

In some examples, the immediate value field 3309 specifies an immediate value for the instruction. An immediate value may be encoded as a 1-byte value, a 2-byte value, a 4-byte value, etc.

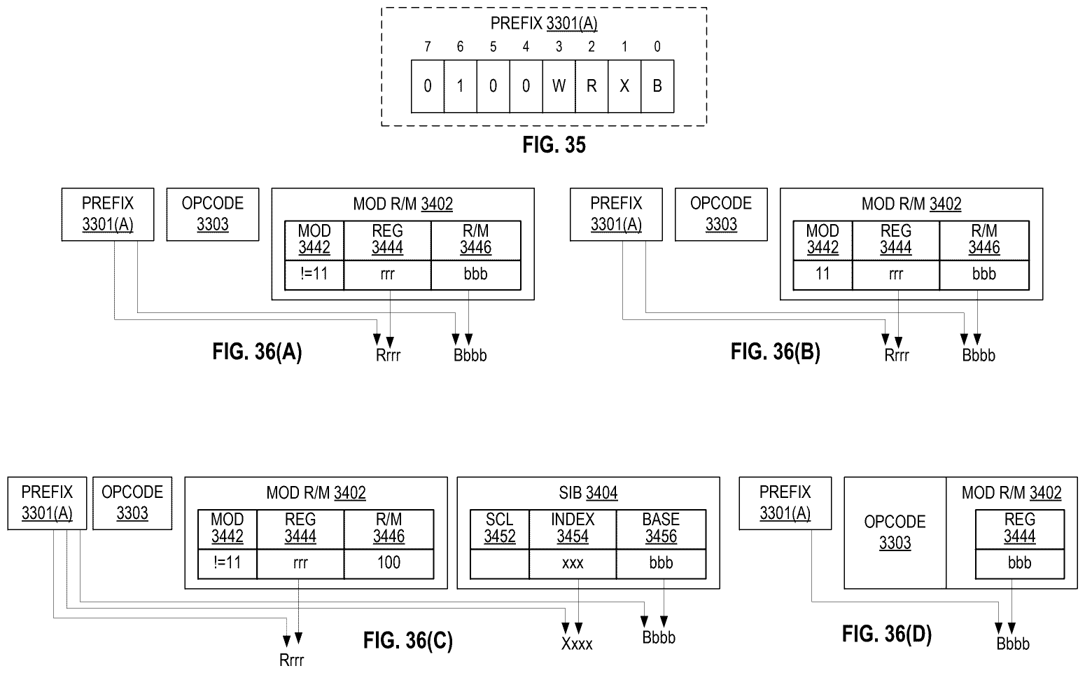

FIG. 35 illustrates examples of a first prefix 3301(A). In some examples, the first prefix 3301(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 3301(A) may specify up to three registers using 3-bit fields depending on the format: 1) using the reg field 3444 and the R/M field 3446 of the MOD R/M byte 3402; 2) using the MOD R/M byte 3402 with the SIB byte 3404 including using the reg field 3444 and the base field 3456 and index field 3454; or 3) using the register field of an opcode.

In the first prefix 3301(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 3444 and MOD R/M R/M field 3446 alone can each only address 8 registers.

In the first prefix 3301(A), bit position 2 (R) may be an extension of the MOD R/M reg field 3444 and may be used to modify the MOD R/M reg field 3444 when that field encodes a general-purpose register, a 64-bit packed data register (e.g., a SSE register), or a control or debug register. R is ignored when MOD R/M byte 3402 specifies other registers or defines an extended opcode.

Bit position 1 (X) may modify the SIB byte index field 3454.

Bit position 0 (B) may modify the base in the MOD R/M R/M field 3446 or the SIB byte base field 3456; or it may modify the opcode register field used for accessing general purpose registers (e.g., general purpose registers 3225).

FIGS. 36(A)-(D) illustrate examples of how the R, X, and B fields of the first prefix 3301(A) are used. FIG. 36(A) illustrates R and B from the first prefix 3301(A) being used to extend the reg field 3444 and R/M field 3446 of the MOD R/M byte 3402 when the SIB byte 34 04 is not used for memory addressing. FIG. 36(B) illustrates R and B from the first prefix 3301(A) being used to extend the reg field 3444 and R/M field 3446 of the MOD R/M byte 3402 when the SIB byte 34 04 is not used (register-register addressing). FIG. 36(C) illustrates R, X, and B from the first prefix 3301(A) being used to extend the reg field 3444 of the MOD R/M byte 3402 and the index field 3454 and base field 3456 when the SIB byte 34 04 being used for memory addressing. FIG. 36(D) illustrates B from the first prefix 3301(A) being used to extend the reg field 3444 of the MOD R/M byte 3402 when a register is encoded in the opcode 3303.

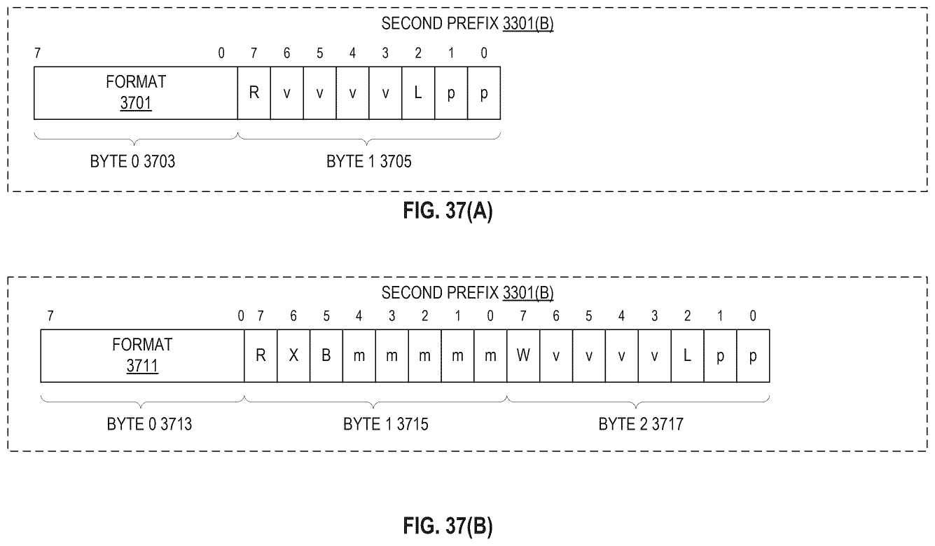

FIGS. 37(A)-(B) illustrate examples of a second prefix 3301 (B). In some examples, the second prefix 3301 (B) is an example of a VEX prefix. The second prefix 3301 (B) encoding allows instructions to have more than two operands, and allows SIMD vector registers (e.g., vector/SIMD registers 3210) to be longer than 64-bits (e.g., 128-bit and 256-bit). The use of the second prefix 3301 (B) provides for three-operand (or more) syntax. For example, previous two-operand instructions performed operations such as A=A+B, which overwrites a source operand. The use of the second prefix 3301 (B) enables operands to perform nondestructive operations such as A=B+C.

In some examples, the second prefix 3301 (B) comes in two forms-a two-byte form and a three-byte form. The two-byte second prefix 3301 (B) is used mainly for 128-bit, scalar, and some 256-bit instructions; while the three-byte second prefix 3301 (B) provides a compact replacement of the first prefix 3301(A) and 3-byte opcode instructions.

FIG. 37(A) illustrates examples of a two-byte form of the second prefix 3301 (B). In one example, a format field 3701 (byte 0 3703) contains the value C5H. In one example, byte 1 3705 includes an “R” value in bit [7]. This value is the complement of the “R” value of the first prefix 3301(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in 1 s complement form for certain vector shifts; or 3) not encode any operand, the field is reserved and should contain a certain value, such as 1111 b.

Instructions that use this prefix may use the MOD R/M R/M field 3446 to encode the instruction operand that references a memory address or encode either the destination register operand or a source register operand.

Instructions that use this prefix may use the MOD R/M reg field 3444 to encode either the destination register operand or a source register operand, or to be treated as an opcode extension and not used to encode any instruction operand.

For instruction syntax that supports four operands, vvvv, the MOD R/M R/M field 3446 and the MOD R/M reg field 3444 encode three of the four operands. Bits [7:4] of the immediate value field 3309 are then used to encode the third source register operand.

FIG. 37(B) illustrates examples of a three-byte form of the second prefix 3301 (B). In one example, a format field 3711 (byte 0 3713) contains the value C4H. Byte 1 3715 includes in bits [7:5] “R,” “X,” and “B” which are the complements of the same values of the first prefix 3301(A). Bits [4:0] of byte 1 3715 (shown as mmmmm) include content to encode, as needed, one or more implied leading opcode bytes. For example, 00001 implies a 0FH leading opcode, 00010 implies a 0F38H leading opcode, 00011 implies a 0F3AH leading opcode, etc.

Bit [7] of byte 2 3717 is used like W of the first prefix 3301(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (1s complement) form and valid for instructions with 2 or more source operands; 2) encode the destination register operand, specified in 1 s complement form for certain vector shifts; or 3) not encode any operand, the field is reserved and should contain a certain value, such as 1111 b.

Instructions that use this prefix may use the MOD R/M R/M field 3446 to encode the instruction operand that references a memory address or encode either the destination register operand or a source register operand.

Instructions that use this prefix may use the MOD R/M reg field 3444 to encode either the destination register operand or a source register operand, or to be treated as an opcode extension and not used to encode any instruction operand.

For instruction syntax that supports four operands, vvvv, the MOD R/M R/M field 3446, and the MOD R/M reg field 3444 encode three of the four operands. Bits [7:4] of the immediate value field 3309 are then used to encode the third source register operand.

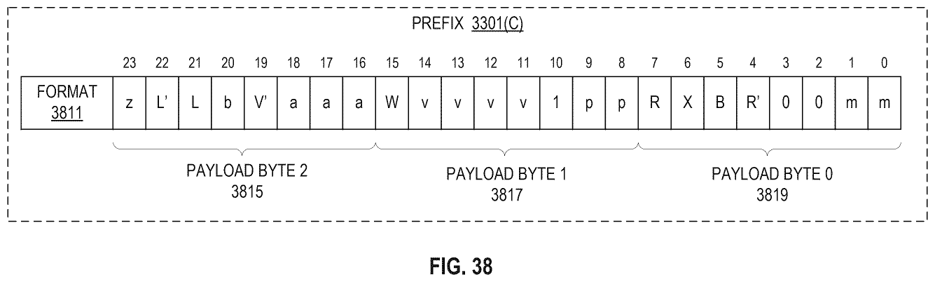

FIG. 38 illustrates examples of a third prefix 3301(C). In some examples, the third prefix 3301(C) is an example of an EVEX prefix. The third prefix 3301(C) is a four-byte prefix.

The third prefix 3301(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 32) or predication utilize this prefix. Opmask register allows for conditional processing or selection control. Opmask instructions, whose source/destination operands are opmask registers and treat the content of an opmask register as a single value, are encoded using the second prefix 3301 (B).

The third prefix 3301(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 3301(C) is a format field 3811 that has a value, in one example, of 62H. Subsequent bytes are referred to as payload bytes 3815-3819 and collectively form a 24-bit value of P[23:0] providing specific capability in the form of one or more fields (detailed herein).

In some examples, P[1:0] of payload byte 3819 are identical to the low two mm bits. P[3:2] are reserved in some examples. Bit P[4] (R′) allows access to the high 16 vector register set when combined with P[7] and the MOD R/M reg field 3444. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 3444 and MOD R/M R/M field 3446. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1 s complement form for certain vector shifts; or 3) not encode any operand, the field is reserved and should contain a certain value, such as 1111 b.

P[15] is like W of the first prefix 3301(A) and second prefix 3311 (B) and may serve as an opcode extension bit or operand size promotion.

P[18:16] specify the index of a register in the opmask (writemask) registers (e.g., writemask/predicate registers 3215). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 3301(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

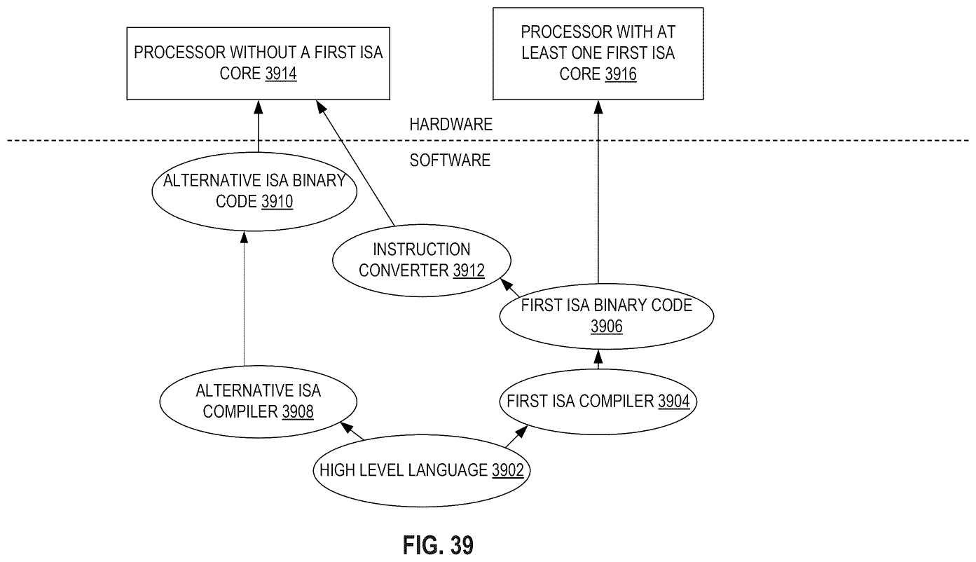

FIG. 39 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 39 shows a program in a high-level language 3902 may be compiled using a first ISA compiler 3904 to generate first ISA binary code 3906 that may be natively executed by a processor with at least one first ISA core 3916. The processor with at least one first ISA core 3916 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 3904 represents a compiler that is operable to generate the first ISA binary code 3906 (e.g., object code) that can, with or without additional linkage processing, be executed on the processor with at least one first ISA core 3916. Similarly, FIG. 39 shows the program in the high-level language 3902 may be compiled using an alternative ISA compiler 3908 to generate alternative ISA binary code 3910 that may be natively executed by a processor without a first ISA core 3914. The instruction converter 3912 is used to convert the first ISA binary code 3906 into code that may be natively executed by the processor without a first ISA core 3914. This converted code is not necessarily to be the same as the alternative ISA binary code 3910; however, the converted code will accomplish the general operation and be made up of instructions from the alternative ISA. Thus, the instruction converter 3912 represents software, firmware, hardware, or a combination thereof that, through emulation, simulation, or any other process, allows a processor or other electronic device that does not have a first ISA processor or core to execute the first ISA binary code 3906.

Components, features, and details described for any of FIGS. 23-27 may also optionally apply to any of FIGS. 21-22. Components, features, and details described for any of the processors disclosed herein (e.g., 2100, 2300, 2400) may optionally apply to any of the methods disclosed herein (e.g., 2226), which in embodiments may optionally be performed by and/or with such processors. Any of the processors described herein (e.g., 2100, 2300, 2400) in embodiments may optionally be included in any of the systems disclosed herein (e.g., any of the systems of FIGS. 28-29). Any of the processors disclosed herein (e.g., 2100, 2300, 2400) may optionally have any of the processor microarchitectures shown herein.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### EXAMPLE EMBODIMENTS

The following examples pertain to further embodiments. Specifics in the examples may be used anywhere in one or more embodiments.

Example 1 is a processor or other apparatus that includes a matrix operations unit. The matrix operations unit is to perform a matrix operation on a first source matrix and a second source matrix to generate a result matrix. The matrix operations unit includes a plurality of sets of circuits. The apparatus also includes a redundant set of circuits, and a comparison unit coupled with the matrix operations unit and coupled with the redundant set of circuits. The comparison unit is to compare a first result generated by an indicated set of circuits of the plurality of sets of circuits with a second result generated by the redundant set of circuits. Each of the first and second results to be generated based on a same set of input data from the first and second source matrices.

Example 2 includes the processor or other apparatus of Example 1, further including a first circuitry, a second circuitry, and a third circuitry. The first circuitry is to indicate the indicated set of circuits, where the first circuitry is to indicate each of the plurality of sets of circuits one at a time. The second circuitry is coupled with the first circuitry. The second circuitry is to select the same set of input data for input to the redundant set of circuits from among a plurality of sets of input data each corresponding to a different one of the plurality of sets of circuits. The third circuitry is coupled with the first circuitry and coupled with the comparison unit. The third circuitry is to select the first result for input to the comparison unit.

Example 3 includes the processor or other apparatus of any one of Examples 1 to 2, where the plurality of sets of circuits are a plurality of columns of multiply-add circuits.

Example 4 includes the processor or other apparatus of any one of Examples 1 to 2, where the plurality of sets of circuits are a plurality of rows of multiply-add circuits.

Example 5 includes the processor or other apparatus of any one of Examples 1 to 2, where each of the plurality of sets of circuits is only a part of either a column of multiply-add circuits or a row of multiply-add circuits.

Example 6 includes the processor or other apparatus of any one of Examples 1 to 5, where the plurality of sets of circuits are a plurality of sets of non-systolic multiply-add circuits.

Example 7 includes the processor or other apparatus of any one of Examples 1 to 6, where the comparison unit is to provide an indication when the first result generated by the indicated set of circuits is not compatible with the second result generated by the redundant set of circuits.

Example 8 includes the processor or other apparatus of Example 7, where the indication is to indicate the indicated set of circuits.

Example 9 includes the processor or other apparatus of any one of Examples 7 to 8, where the indication is to indicate a decoded instruction used to control the indicated set of circuits to generate the first result.

Example 10 includes the processor or other apparatus of any one of Examples 1 to 9, further including a control and/or configuration register to store one or more bits. The one or more bits to have at least a first value to enable use of the redundant set of circuits and the comparison unit and a second value to disable use of the redundant set of circuits and the comparison unit.

Example 11 includes the processor or other apparatus of any one of Examples 1 to 10, further including a control and/or configuration register to store one or more bits. The one or more bits are to control a rate at which to repeat indicating each of the plurality of sets of circuits one at a time.

Example 12 includes the processor or other apparatus of any one of Examples 1 to 11, further including circuitry to reconfigure the redundant set of circuits to replace one of the plurality of sets of circuits.

Example 13 is a method (e.g., performed by a processor) that includes generating a result matrix by performing a matrix operation on a first source matrix and a second source matrix with a matrix operations unit. The generation of the result matrix includes generating a first result with a first set of circuits, of a plurality of sets of circuits of the matrix operations unit, based on a set of input data from the first and second source matrices. The method also includes generating a second result with a redundant set of circuits. The second result was generated based on the set of input data from the first and second source matrices. The method also includes comparing the first result and the second result.

Example 14 includes the method of Example 13, further including selecting the first set of circuits from among the plurality of sets of circuits, selecting the set of input data for input to the redundant set of circuits from among a plurality of sets of input data each corresponding to a different one of the plurality of sets of circuits, and selecting the first result, from among a plurality of results each generated by a different one of the plurality of sets of circuits, for comparison with the second result.

Example 15 includes the method of any one of Examples 13 to 14, where the plurality of sets of circuits are either a plurality of columns of multiply-add circuits or a plurality of rows of multiply-add circuits.

Example 16 includes the method of any one of Examples 13 to 15, where the plurality of sets of circuits are a plurality of sets of non-systolic multiply-add circuits.

Example 17 is a system including an interconnect and a processor coupled with the interconnect. The processor includes a matrix operations unit. The matrix operations unit is to perform a matrix operation on a first source matrix and a second source matrix to generate a result matrix. The matrix operations unit includes a plurality of sets of circuits. The processor also includes a redundant set of circuits and a comparison unit coupled with the matrix operations unit and coupled with the redundant set of circuits. The comparison unit is to compare a first result generated by an indicated set of circuits of the plurality of sets of circuits with a second result generated by the redundant set of circuits. Each of the first and second results to be generated based on a same set of input data from the first and second source matrices. The system also includes a dynamic random access memory (DRAM) coupled with the interconnect.

Example 18 includes the system of Example 17, where the processor further includes a first circuitry, a second circuitry, and a third circuitry. The first circuitry is to indicate the indicated set of circuits, where the first circuitry is to indicate each of the plurality of sets of circuits one at a time. The second circuitry is coupled with the first circuitry. The second circuitry is to select the same set of input data for input to the redundant set of circuits from among a plurality of sets of input data each corresponding to a different one of the plurality of sets of circuits. The third circuitry is coupled with the first circuitry and coupled with the comparison unit. The third circuitry to select the first result for input to the comparison unit.

Example 19 includes the system of any one of Examples 17 to 18, where the plurality of sets of circuits are either a plurality of columns of multiply-add circuits or a plurality of rows of multiply-add circuits, and optionally where the plurality of sets of circuits are a plurality of sets of non-systolic multiply-add circuits.

Example 20 includes the system of any one of Examples 17 to 19, where the comparison unit is to provide an indication when the first result generated by the indicated set of circuits is not compatible with the second result generated by the redundant set of circuits, and optionally where the indication is to indicate the indicated set of circuits.

Example 21 is a processor or other apparatus operative to perform the method of any one of Examples 13 to 16.

Example 22 is a processor or other apparatus that includes means for performing the method of any one of Examples 13 to 16.

Example 23 is a processor or other apparatus that includes any combination of modules and/or units and/or logic and/or circuitry and/or means operative to perform the method of any one of Examples 13 to 16.

Example 24 is an optionally non-transitory and/or tangible machine-readable medium, which optionally stores or otherwise provides instructions, the instructions if and/or when executed by a processor, computer system, electronic device, or other machine, are operative to cause the machine to perform the method of any one of Examples 13 to 16.

What is claimed is:

1. A processor comprising:
a matrix operations unit, the matrix operations unit to perform a matrix operation on a first source matrix and a second source matrix to generate a result matrix, the matrix operations unit including a plurality of sets of circuits;
a redundant set of circuits; and
a comparison unit coupled with the matrix operations unit and coupled with the redundant set of circuits, the comparison unit to compare a first result generated by an indicated set of circuits of the plurality of sets of circuits with a second result generated by the redundant set of circuits, each of the first and second results to be generated based on a same set of input data from the first and second source matrices.

2. The processor of claim 1, further comprising:
a first circuitry to indicate the indicated set of circuits, wherein the first circuitry is to indicate each of the plurality of sets of circuits one at a time;
a second circuitry coupled with the first circuitry, the second circuitry to select the same set of input data for input to the redundant set of circuits from among a plurality of sets of input data each corresponding to a different one of the plurality of sets of circuits; and
a third circuitry coupled with the first circuitry and coupled with the comparison unit, the third circuitry to select the first result for input to the comparison unit.

3. The processor of claim 1, wherein the plurality of sets of circuits are a plurality of columns of multiply-add circuits.

4. The processor of claim 1, wherein the plurality of sets of circuits are a plurality of rows of multiply-add circuits.

5. The processor of claim 1, wherein each of the plurality of sets of circuits is only a part of either a column of multiply-add circuits or a row of multiply-add circuits.

6. The processor of claim 1, wherein the plurality of sets of circuits are a plurality of sets of non-systolic multiply-add circuits.

7. The processor of claim 1, wherein the comparison unit is to provide an indication when the first result generated by the indicated set of circuits is not compatible with the second result generated by the redundant set of circuits.

8. The processor of claim 7, wherein the indication is to indicate the indicated set of circuits.

9. The processor of claim 7, wherein the indication is to indicate a decoded instruction used to control the indicated set of circuits to generate the first result.

10. The processor of claim 1, further comprising a control and/or configuration register to store one or more bits, the one or more bits to have at least a first value to enable use of the redundant set of circuits and the comparison unit and a second value to disable use of the redundant set of circuits and the comparison unit.

11. The processor of claim 1, further comprising a control and/or configuration register to store one or more bits, the one or more bits to control a rate at which to repeat indicating each of the plurality of sets of circuits one at a time.

12. The processor of claim 1, further comprising circuitry to reconfigure the redundant set of circuits to replace one of the plurality of sets of circuits.

13. A method comprising:
generating a result matrix by performing a matrix operation on a first source matrix and a second source matrix with a matrix operations unit, wherein the generating the result matrix includes generating a first result with a first set of circuits, of a plurality of sets of circuits of the matrix operations unit, based on a set of input data from the first and second source matrices;
generating a second result with a redundant set of circuits, the second result generated based on the set of input data from the first and second source matrices; and
comparing the first result and the second result.

14. The method of claim 13, further comprising:
selecting the first set of circuits from among the plurality of sets of circuits;
selecting the set of input data for input to the redundant set of circuits from among a plurality of sets of input data each corresponding to a different one of the plurality of sets of circuits; and
selecting the first result, from among a plurality of results each generated by a different one of the plurality of sets of circuits, for comparison with the second result.

15. The method of claim 13, wherein the plurality of sets of circuits are either a plurality of columns of multiply-add circuits or a plurality of rows of multiply-add circuits.

16. The method of claim 13, wherein the plurality of sets of circuits are a plurality of sets of non-systolic multiply-add circuits.

17. A system comprising:
an interconnect;
a processor coupled with the interconnect, the processor including:
a matrix operations unit, the matrix operations unit to perform a matrix operation on a first source matrix and a second source matrix to generate a result matrix, the matrix operations unit including a plurality of sets of circuits;
a redundant set of circuits; and
a comparison unit coupled with the matrix operations unit and coupled with the redundant set of circuits, the comparison unit to compare a first result generated by an indicated set of circuits of the plurality of sets of circuits with a second result generated by the redundant set of circuits, each of the first and second results to be generated based on a same set of input data from the first and second source matrices; and
a dynamic random access memory (DRAM) coupled with the interconnect.

18. The system of claim 17, wherein the processor further comprises:
a first circuitry to indicate the indicated set of circuits, wherein the first circuitry is to indicate each of the plurality of sets of circuits one at a time;
a second circuitry coupled with the first circuitry, the second circuitry to select the same set of input data for input to the redundant set of circuits from among a plurality of sets of input data each corresponding to a different one of the plurality of sets of circuits; and
a third circuitry coupled with the first circuitry and coupled with the comparison unit, the third circuitry to select the first result for input to the comparison unit.

19. The system of claim 17, wherein the plurality of sets of circuits are either a plurality of columns of multiply-add circuits or a plurality of rows of multiply-add circuits, and wherein the plurality of sets of circuits are a plurality of sets of non-systolic multiply-add circuits.

20. The system of claim 17, wherein the comparison unit is to provide an indication when the first result generated by the indicated set of circuits is not compatible with the second result generated by the redundant set of circuits, and wherein the indication is to indicate the indicated set of circuits.
